(19) United States
(12) Patent Application Publication
(10) Pub. No.: US 2026/0058699 A1
(43) Pub. Date: Feb. 26, 2026

(54) UL CODEBOOK ADAPTATION FOR PUSCH

(71) Applicant: QUALCOMM Incorporated, San Diego, CA (US)

(72) Inventors: Kexin XIAO, Shanghai (CN); Yi HUANG, San Diego, CA (US); Yu ZHANG, San Diego, CA (US)

(21) Appl. No.: 19/106,982

(22) PCT Filed: Oct. 10, 2022
(86) PCT No.: PCT/CN2022/124294

§ 371 Date: Feb. 26, 2025

(51) Int. Cl. H04B 7/0456; H04W 24/08; H04W 72/1268

(52) U.S. Cl. CPC H04B 7/0456; H04W 24/08; H04W 72/1268

(57) ABSTRACT

Apparatus, methods, and computer program products for wireless communication are provided. An example method may include transmitting, for a second network entity, information indicative of partitioning of one or more subsets of codebooks in a configured set of codebooks and information indicative of one recommended subset of codebooks in the one or more subsets of codebooks, where each respective codebook in the set of codebooks corresponds to a respective precoder. The example method may further include receiving, in an uplink grant from the second network entity, information indicative of a selected codebook in the recommended subset of codebooks. The example method may further include transmitting a PUSCH transmission based on the selected codebook and the uplink grant.

### TECHNICAL FIELD

The present disclosure relates generally to communication systems, and more particularly, to wireless communication systems with codebook based transmissions.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a first network entity, such as a user equipment (UE), are provided. The apparatus may include a memory and at least one processor coupled to the memory. The at least one processor may be configured to transmit, for a second network entity, information indicative of partitioning of one or more subsets of codebooks in a configured set of codebooks and information indicative of one recommended subset of codebooks in the one or more subsets of codebooks, where each respective codebook in the set of codebooks corresponds to a respective precoder. The at least one processor may be configured to receive, in an uplink grant from the second network entity, information indicative of a selected codebook in the recommended subset of codebooks. The at least one processor may be configured to transmit a physical uplink shared channel (PUSCH) transmission based on the selected codebook and the uplink grant. The at least one processor may be configured to receive, from a second network entity, information indicative of partitioning of one or more subsets of codebooks in a configured set of codebooks and one recommended subset of codebook in the one or more subsets of codebooks, where each respective codebook in the set of codebooks corresponds to a respective precoder. The at least one processor may be configured to receive, in an uplink grant from the second network entity, information indicative of a selected codebook in the recommended subset of codebooks. The at least one processor may be configured to transmit a PUSCH transmission based on the selected codebook and the uplink grant.

In another aspect of the disclosure, a method, a computer-readable medium, and an apparatus at a first network entity, such as a network node (e.g., a network node such as a base station), are provided. The apparatus may include a memory and at least one processor coupled to the memory. The at least one processor may be configured to receive information indicative of partitioning of one or more subsets of codebooks in a configured set of codebooks for a second network entity and information indicative of one recommended subset of codebooks in the one or more subsets of codebooks, where each respective codebook in the set of codebooks corresponds to a respective precoder. The at least one processor may be configured to transmit, in an uplink grant for the second network entity, information indicative of a selected codebook in the recommended subset of codebooks. The at least one processor may be configured to receive a PUSCH transmission based on the selected codebook and the uplink grant. The at least one processor may be configured to transmit information indicative of partitioning of one or more subsets of codebooks in a configured set of codebooks for a second network entity and one recommended subset of codebook in the one or more subsets of codebooks, where each respective codebook in the set of codebooks corresponds to a respective precoder. The at least one processor may be configured to transmit, in an uplink grant for the second network entity, information indicative of a selected codebook in the recommended subset of codebooks. The at least one processor may be configured to receive a PUSCH transmission based on the selected codebook and the uplink grant.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating example communications between a network entity and a UE.

FIG. 5A is a diagram illustrating example uniform linear array (ULA) antenna.

FIG. 5B is a diagram illustrating example uniform planar array (UPA) antenna.

FIG. 6 is a diagram illustrating example evaluation of different codebook candidates.

FIG. 7 is a diagram illustrating example evaluation of different codebook candidates.

FIG. 8 is a diagram illustrating example communications between a network entity and a UE.

FIG. 9 is a diagram illustrating example communications between a network entity and a UE.

FIG. 10 is a flowchart of a method of wireless communication.

FIG. 11 is a flowchart of a method of wireless communication.

FIG. 12 is a flowchart of a method of wireless communication.

FIG. 13 is a flowchart of a method of wireless communication.

FIG. 14 is a flowchart of a method of wireless communication.

FIG. 15 is a flowchart of a method of wireless communication.

FIG. 16 is a flowchart of a method of wireless communication.

FIG. 17 is a flowchart of a method of wireless communication.

FIG. 18 is a diagram illustrating an example of a hardware implementation for an example apparatus and/or network entity.

FIG. 19 is a diagram illustrating an example of a hardware implementation for an example network entity.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

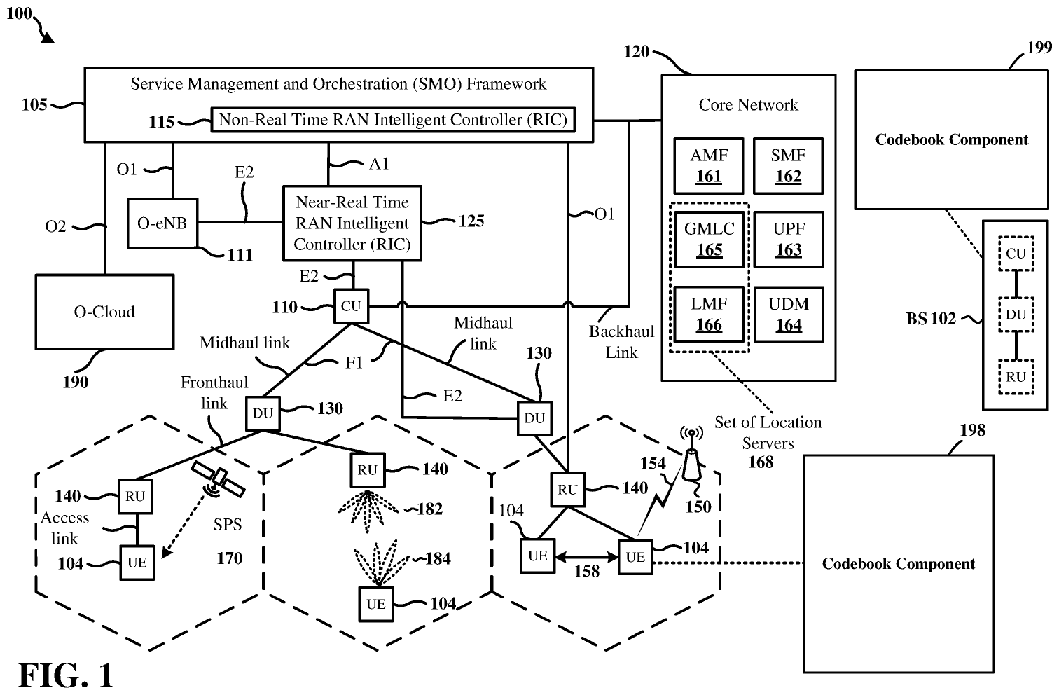

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU.

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include a codebook component 198. In some aspects, the codebook component 198 may be configured to transmit, for a second network entity, information indicative of partitioning of one or more subsets of codebooks in a configured set of codebooks and information indicative of one recommended subset of codebooks in the one or more subsets of codebooks, where each respective codebook in the set of codebooks corresponds to a respective precoder. In some aspects, the codebook component 198 may be configured to receive, in an uplink grant from the second network entity, information indicative of a selected codebook in the recommended subset of codebooks. In some aspects, the codebook component 198 may be configured to transmit a PUSCH transmission based on the selected codebook and the uplink grant. In some aspects, the codebook component 198 may be configured to receive, from a second network entity, information indicative of partitioning of one or more subsets of codebooks in a configured set of codebooks and one recommended subset of codebook in the one or more subsets of codebooks, where each respective codebook in the set of codebooks corresponds to a respective precoder. In some aspects, the codebook component 198 may be configured to receive, in an uplink grant from the second network entity, information indicative of a selected codebook in the recommended subset of codebooks. In some aspects, the codebook component 198 may be configured to transmit a PUSCH transmission based on the selected codebook and the uplink grant.

In certain aspects, the base station 102 may include a codebook component 199. In some aspects, the codebook component 199 may be configured to receive information indicative of partitioning of one or more subsets of codebooks in a configured set of codebooks for a second network entity and information indicative of one recommended subset of codebooks in the one or more subsets of codebooks, where each respective codebook in the set of codebooks corresponds to a respective precoder. In some aspects, the codebook component 199 may be configured to transmit, in an uplink grant for the second network entity, information indicative of a selected codebook in the recommended subset of codebooks. In some aspects, the codebook component 199 may be configured to receive a PUSCH transmission based on the selected codebook and the uplink grant. In some aspects, the codebook component 199 may be configured to transmit information indicative of partitioning of one or more subsets of codebooks in a configured set of codebooks for a second network entity and one recommended subset of codebook in the one or more subsets of codebooks, where each respective codebook in the set of codebooks corresponds to a respective precoder. In some aspects, the codebook component 199 may be configured to transmit, in an uplink grant for the second network entity, information indicative of a selected codebook in the recommended subset of codebooks. In some aspects, the codebook component 199 may be configured to receive a PUSCH transmission based on the selected codebook and the uplink grant.

Although the following description may be focused on 5G NR, the concepts described herein may be applicable to other similar areas, such as LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

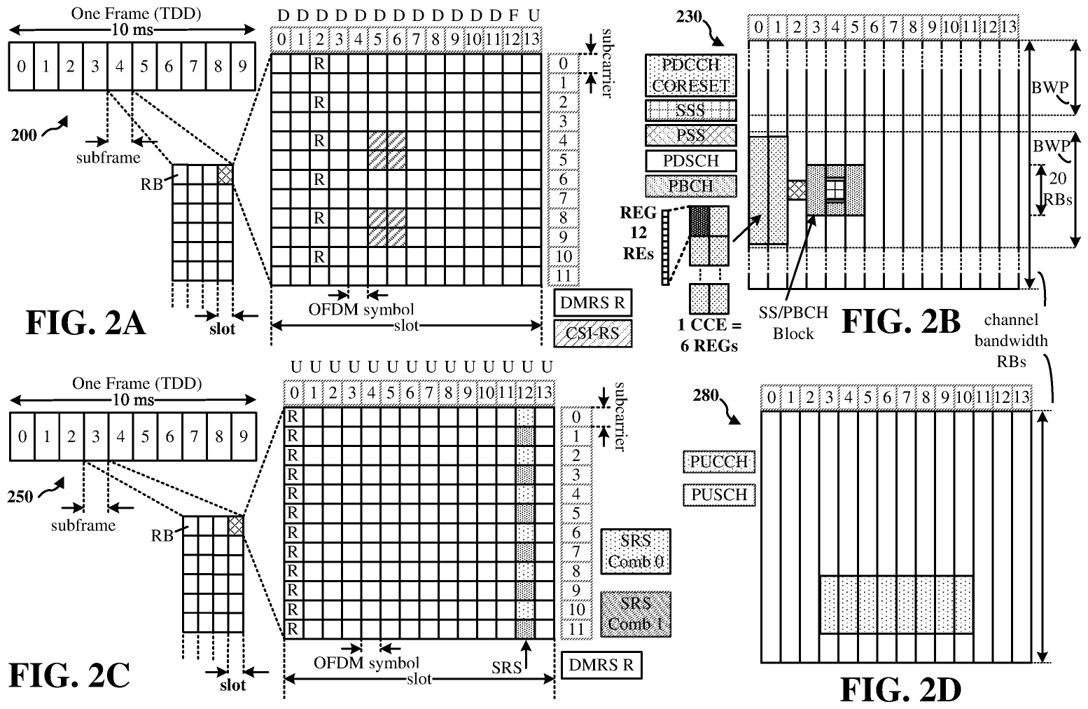

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI).

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

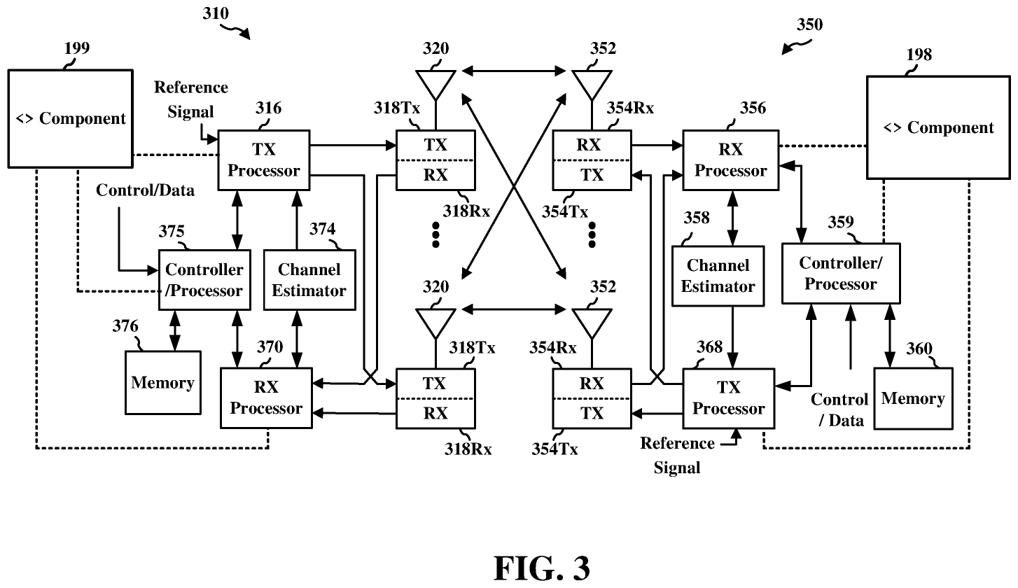

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with codebook component 198 of FIG. 1.

At least one of the TX processor 316, the RX processor 370, and the controller/processor 375 may be configured to perform aspects in connection with codebook component 199 of FIG. 1.

A set of time and frequency resources that may be used for one or more transmissions of SRS may be referred to as an “SRS resource set.” In some communication systems, the SRS resource set applicability (i.e., what the SRS resource set is used for) for an SRS resource set may be configured by a higher layer parameter, such as “usage” associated with the SRS resource set, such as in the SRS-ResourceSet parameter. For example, usage may be configured as one of beam management, codebook (e.g., for codebook-based transmission), non-codebook (e.g., for non-codebook-based transmission), antenna switching, or the like. Each SRS resource set may be configured with one or more (such as up to 16) SRS resources. Each SRS resource set may be aperiodic, semi-persistent, or periodic.

In some wireless communication systems, two types of PUSCH transmissions, codebook-based transmission and non-codebook-based transmission, may be supported. For non-codebook-based transmission, a UE may be configured with one SRS resource set with “usage” set to “non-codebook.” For example, a maximum of 4 SRS resources within the set may be configured for the UE. Each SRS resource may be RRC configured with one port. The SRI field in the UL DCI scheduling the PUSCH may indicate one or more SRS resources. A number of indicated SRS resources may determine the rank (i.e., number of layers) for the scheduled PUSCH. The PUSCH may be transmitted with the same precoder as well as a same spatial domain filter (i.e., beam) as the indicated SRS resources.

For codebook-based transmission, a UE may be configured with one SRS resource set with “usage” set to “codebook.” For example, a maximum of 4 SRS resources within the set may be configured for the UE. Each SRS resource may be radio resource control (RRC) configured with a number of ports, such as one or more ports. The SRS resource indicator (SRI) field in the UL DCI scheduling the PUSCH may indicate one SRS resource. The number of ports configured for the indicated SRS resource may determine number of antenna ports for the PUSCH. The PUSCH may be transmitted with the same spatial domain filter (which may be otherwise referred to as a “beam”) as the indicated SRS resources. The number of layers (i.e., rank) or transmitted precoding matrix indicator (TPMI) (e.g., for precoder) for the scheduled PUSCH may be determined from a separate DCI field “Precoding information and number of layers.” The TPMI may be used for indicating a precoding matrix. In some aspects, one TPMI may correspond to one precoding matrix. By transmitting the TPMI, a network may communicate with a UE regarding a particular precoding matrix is selected for an uplink transmission. For example, for each PUSCH, in the UL grant, the network may signal a precoder to use in the codebook based on TPMI. In some aspects, for each PUSCH slot, in the UL grant, the network may signal a precoder to use in the codebook based on TPMI. In some aspects, precoder may be different for each PUSCH slot.

In codebook-based uplink shared-channel transmission, the network selects the transmission rank and the corresponding precoding matrix and informs the device through uplink scheduling grant. The term “a configured set of codebooks” may refer to a set of configured precoding matrices (that may each correspond to a precoder) at a UE and a network used for precoding (e.g., which may also be referred to as “a whole codebook,” “an entire codebook,” or “a codebook”). The configured set of codebooks may be configured without signaling between the UE and the network. Based on aspects provided herein, the configured set of codebooks may be partitioned to different subsets of codebooks. As used herein, the term “a subset of codebooks” may refer to a subset of the “configured set of codebooks” that may be configured based on partitioning determined by the UE or the network and facilitated by signaling between the UE and the network. For example, a UE may determine how the configured set of codebooks may be partitioned to different subsets and the precoding matrices included in each subset, then transmit information indicative of how the configured set of codebooks may be partitioned to different subsets and the precoding matrices included in each subset to the network. As another example, a network may determine how the configured set of codebooks may be partitioned to different subsets and the precoding matrices included in each subset, then transmit information indicative of how the configured set of codebooks may be partitioned to different subsets and the precoding matrices included in each subset to the UE. As used herein, the information indicative of how the configured set of codebooks may be partitioned to different subsets and the precoding matrices included in each subset may be referred to as “partitioning.” As used herein, the term “recommended subset of codebooks” may refer to a particular subset of codebooks that may be recommended or selected (e.g., by the UE or the network) to be suitable for usage for the UE. As used herein, the term “local antenna blockage” may refer to an antenna blockage at a wireless caused by human, such as antenna blockage caused by hand, finger, head, or other parts of the human body. A local antenna blockage may be dependent on how a human may be interacting with the wireless device. Precoding is the process of preprocessing of transmit signals based on a precoder. Based on a precoder, a wireless device may apply weights on to the antenna element that includes amplitude and phase for each antenna element. The term “precoder” may correspond to a “precoding matrix” and may refer to parameters used in the precoding process and may be indicated as a “codebook candidate” or “codebook” in the configured set of codebooks. With the help of weights, the antenna can be electronically steered to radiate in the intended direction by suppressing the power in the other directions. In some wireless communication systems, a UE may support eight transmission channels (8 Tx) UL operation to support 4 and more layers per UE. To support such operations, the configured set of codebooks configured for the UE may include a large amount of precoders. As used herein, the term “uplink grant” may refer to information transmitted from a network node to a UE associated with transmission of an uplink transmission. An uplink grant may trigger the uplink transmission and may be associated with time and frequency resources for the uplink transmission.

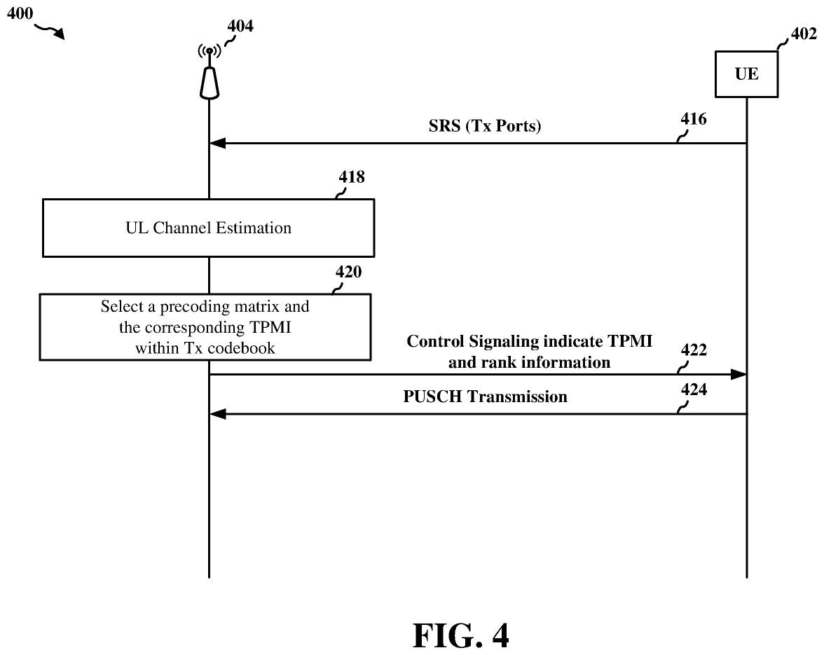

FIG. 4 is a diagram 400 illustrating example communications between a network entity 404 and a UE 402. The network entity 404 may be a network node. A network node may be implemented as an aggregated base station, a disaggregated base station, an integrated access and backhaul (IAB) node, a relay node, a sidelink node, or the like. A network entity can be implemented in an aggregated or monolithic base station architecture, or alternatively, in a disaggregated base station architecture, and may include one or more of a CU, a DU, a RU, a Near-Real Time (Near-RT) RAN Intelligent Controller (RIC), or a Non-Real Time (Non-RT) RIC.

As illustrated in FIG. 4, the UE 402 may transmit one or more SRS 416 to the network entity 404. Based on the one or more SRS 416, the network entity 404 may perform channel estimation at 418. For example, the one or more SRS 416 may be used by the network entity 404 to estimate the quality of the uplink channel for large bandwidths outside the assigned span to the UE 402. The one or more SRS 416 may be generated using a base sequence that may have small power variations in time and frequency, which may result in high power amplifier efficiency and comparable channel estimation quality for all frequency components. In some aspects, the uplink channel may be denoted by Ĥ_{UL}. In some aspects, the uplink channel may be estimated based on Rx and Tx (e.g., Rx×Tx) associated with the one or more SRS 416. After performing the channel estimation at 418, in some aspects, at 420, the network entity 404 may select a precoding matrix and the corresponding TPMI from the configured set of codebooks.

After selecting the precoding matrix and the corresponding TPMI at 420, the network entity 404 may transmit control information 422 to indicate, to the UE 402, TPMI and rank information associated with the precoding matrix selected at 420. In some aspects, the control information 422 may be included in an uplink grant associated with (e.g., triggering) a PUSCH transmission 424. Based on the TPMI and the rank information, the UE 402 may identify the precoding matrix selected at 420 and use the selected precoding matrix to transmit the PUSCH transmission 424 to the network entity 404. In some aspects, the precoding matrix selected at 420 may be different per each PUSCH transmission or per each slot.

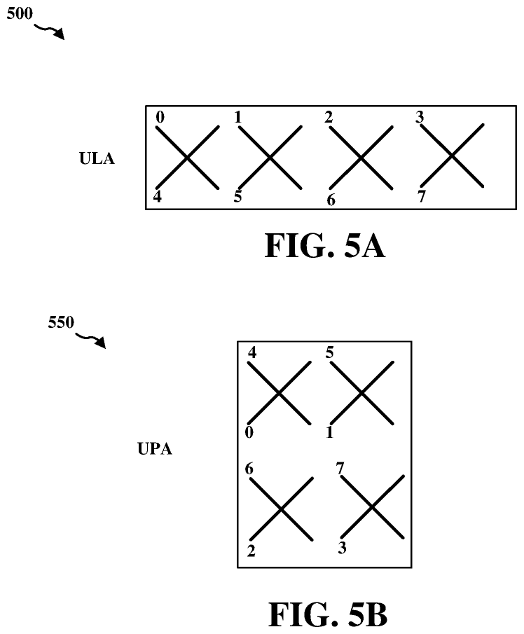

FIG. 5A is a diagram 500 illustrating example uniform linear array (ULA) antenna. As illustrated in FIG. 5A, ULA antenna may include antennas spaced (e.g., equally spaced) along a straight line. FIG. 5B is a diagram 550 illustrating example uniform planar array (UPA) antenna. As illustrated in FIG. 51B, UPA antenna may include individual antennas positioned along a rectangular grid to form a planar array.

Some example codebooks that may be configured at a UE and a network for UL are provided in table 2 below:

TABLE 2

| | 8Tx Alt1-b DFT precoder | | 8Tx Alt1-b non-DFT |
|---|---|---|---|
| | Rel-15 DL Type | | precoder |
| Rank\TPMI | I (M, N, P) = | Rel-15 DL Type I (M, N, | Rel-15 UL 4Tx and co- |
| size | (1, 4, 2), FC | P) = (2, 2, 2), FC | phasing |
| Rank 1 | 16 (O1 = 1, i2 = 4) | 64 (O1/O2 = 2, i2 = 4) | 16 * 16 * 2 = 512 |
| Rank 2 | 8 (O1 = 1, i2 = 2) | 32 (O1/O2 = 2, i2 = 2, | 8 * 8 * 4 = 128 |
| | | i13 = 0) | |
| Rank 3 | 8 (O1 = 1, i2 = 2) | 32 (O1/O2 = 2, 12 = 2, | 4 * 4 * 4 = 64 |
| | | i13 = 0) | |
| Rank 4 | 8 (O1 = 1, i2 = 2) | 32 (O1/O2 = 2, 12 = 2 | 2 * 2 * 4 = 16 |
| | | i13 = 0) | |
| Rank 5 | 8 (O1 = 1, i2 = 2) | 32 (O1/O2 = 2, i2 = 2) | 2*2*2*2 = 16 |
| Rank 6 | 8 (O1 = 1, i2 = 2) | 32 (O1/O2 = 2, i2 = 2) | 2*2*2*2 = 16 |
| Rank 7 | 4 (O1 = 1, i2 = 2) | 32 (O1/O2 = 2, i2 = 2) | 2*2*2*2*2 = 32 |
| Rank 8 | 4 (O1 = 1, i2 = 2) | 32 (O1/O2 = 2, i2 = 2) | 2*2*2*2*2 = 32 |
| Sum of TPMI | 64 | 288 | 944 |

The parameters M, N, P may be used to indicate different antenna layout. The parameters O1 and O2 may correspond to configuration of sampling factor. The parameters i1 and i2 may correspond to feedback report values. As illustrated in Table 2, for fully coherent structure, different antenna layout may correspond to different codebooks. A UE with fully coherent structure (e.g., capability to have fully coherent structure) may be able to control and maintain the same phase offset between antennas for PUSCH transmissions as for the prior SRS transmissions. To cover all potential types of UE antenna layout, signaling overhead for TPMI indication for a PUSCH transmission may be large. Aspects provided herein may reduce signaling overhead for TPMI indication for a PUSCH transmission by partitioning the configured set of codebooks into subset of codebooks. After partitioning the configured set of codebooks into subset of codebooks, the UE or the network may recommend or select a recommended subset of codebooks and indicate the recommended subset of codebooks to the other entity (the network or the UE). Therefore, signaling overhead for TPMI indication may be reduced because the bits used for indicating a TPMI in the recommended subset of codebooks may be smaller than the bits used for indicating a TPMI in the configured set of codebooks. By reducing signaling overhead for TPMI indication, the overall efficiency and data rate of the communication system may be increased.

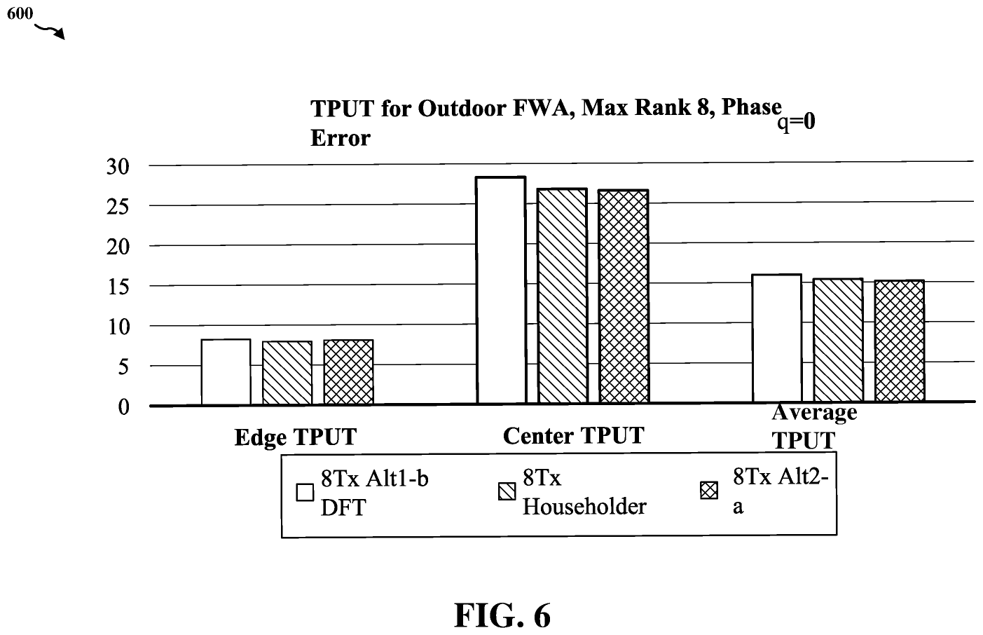

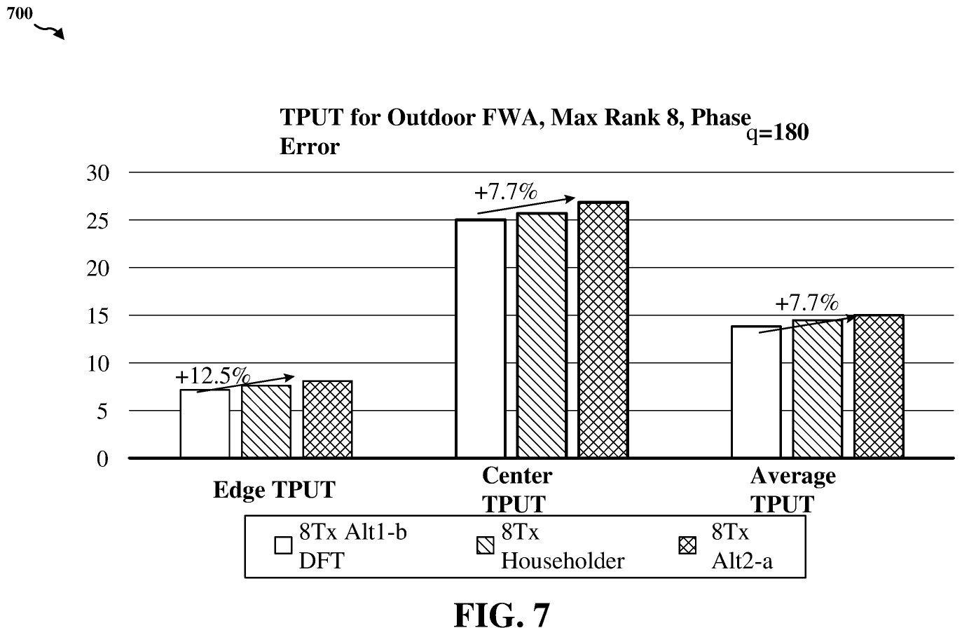

FIG. 6 is a diagram 600 illustrating example evaluation of different codebook candidates. Alt2-a precoder may be 2TX/4TX codebooks and/or 8×1 antenna selection vector(s) as the starting point for design of codebook for fully/partially/non-coherent UEs. Alt1-b precoder may be UL 2TX/4TX codebooks and/or 8×1 antenna selection vector(s) as the starting point for design of the codebook for partially/non-coherent UEs and Type I codebook as the starting point for design of the codebook for fully-coherent UEs. Type 1 codebook may be based on a defined table of codebook that may include entries with different antenna layout, different number of antennas, different sampling factor, or the like. Type 2 codebook may be based on one or more formulas. “TPUT” may be throughout, “FWA” may be fixed wireless access. Edge TPUT may be throughout at an edge of coverage. Center TPUT may be throughout at a center of coverage. FIG. 7 is a diagram 700 illustrating example evaluation of different codebook candidates.

As described herein, for a certain UE, based on its antenna layout, using a particular subset (e.g., recommended subset) of codebooks in the entire configured set of codebooks may be sufficient. The configured set of codebooks may be partitioned into several subsets based on a partitioning determined by the UE or the network. Number of bits to signal one precoder (e.g., by indicating TPMI associated with the precoder) may be accordingly reduced.

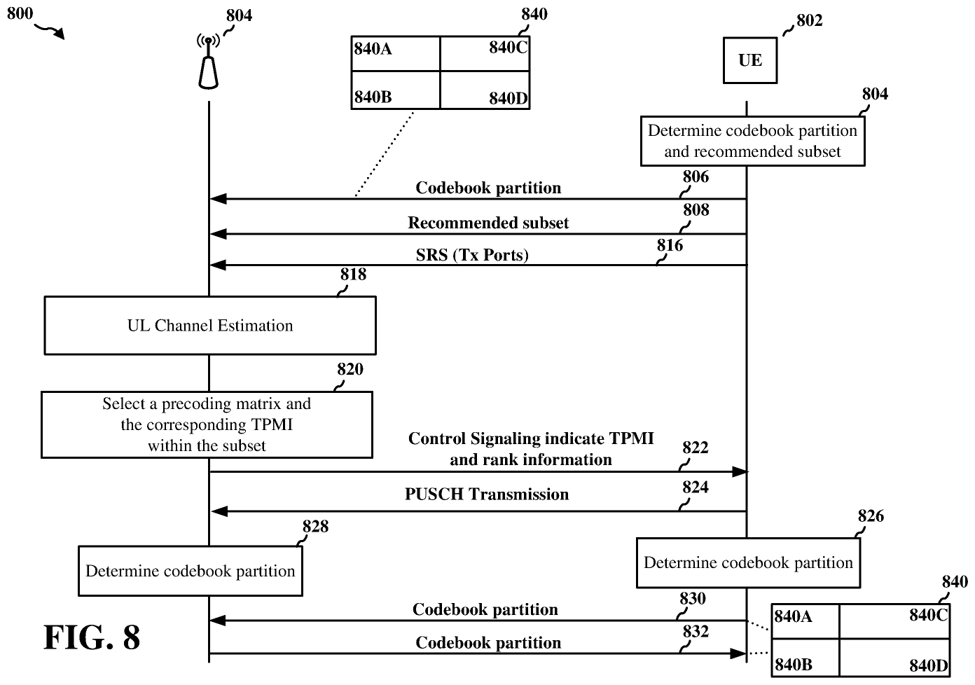

In some aspects, the UE may determine partitioning of the configured set of codebooks. FIG. 8 is a diagram 800 illustrating example communications between a network entity 804 and a UE 802.

The network entity 804 may be a network node. A network node may be implemented as an aggregated base station, a disaggregated base station, an integrated access and backhaul (IAB) node, a relay node, a sidelink node, or the like. A network entity can be implemented in an aggregated or monolithic base station architecture, or alternatively, in a disaggregated base station architecture, and may include one or more of a CU, a DU, a RU, a Near-Real Time (Near-RT) RAN Intelligent Controller (RIC), or a Non-Real Time (Non-RT) RIC.

As illustrated in FIG. 8, the UE 802 may determine codebook partition and recommended subset of codebooks at 804 based on the UE's antenna layout. In some aspects, the UE 802 may determine codebook partition and recommended subset of codebooks at 804 further based on the UE's local antenna blockage, the UE's power consumption, or the UE's DL channel measurement (assuming DL/UL channel reciprocity). In some aspects, the UE 802 may determine codebook partition and recommended subset of codebooks at 804 based on other parameters. In some aspects, the codebook partition determined at 804 may be an initial codebook partition that may be updated later by the network entity 804 or the UE 802. In some aspects, the initial codebook partition may be determined based on the UE's antenna layout. In some aspects, the initial codebook partition may be reported to the network entity 804 as part of capability information associated with the UE 802, which may also include coherency reporting (reporting whether the UE 802 is fully coherent, partially coherent, or not coherent) and may be reported via radio resource control (RRC) signaling.

In some aspects, after determining codebook partition and recommended subset of codebooks at 804, the UE 802 may transmit information indicative of the codebook partition 806 and information indicative of the recommended subset of codebooks 808 to the network entity 804 (e.g., via medium access control (MAC) control element (MAC-CE), RRC signaling, or control information). In some aspects, as illustrated in FIG. 8, based on the codebook partition 806, a configured set of codebooks 840 may be partitioned into a first subset 840A, a second subset 840B, a third subset 840C, and a fourth subset 840D. As an example, the recommended subset of codebooks 808 may be the subset 840A.

As illustrated in FIG. 8, the UE 802 may transmit one or more SRS 816 to the network entity 804. Based on the one or more SRS 816, the network entity 804 may perform channel estimation at 818. For example, the one or more SRS 816 may be used by the network entity 804 to estimate the quality of the uplink channel for large bandwidths outside the assigned span to the UE 802. The one or more SRS 816 may be generated using a base sequence that may have small power variations in time and frequency, which may result in high power amplifier efficiency and comparable channel estimation quality for all frequency components. In some aspects, the uplink channel may be denoted by Ĥ_{UL}. In some aspects, the uplink channel may be estimated based on Rx and Tx (e.g., Rx×Tx) associated with the one or more SRS 816. After performing the channel estimation at 818, in some aspects, at 820, the network entity 804 may select a precoding matrix and the corresponding TPMI from the recommended subset of codebooks 808. In some aspects, the precoding matrix selected at 820 may be different per each PUSCH transmission or per each slot.

After selecting the precoding matrix and the corresponding TPMI from the recommended subset of codebooks 808 at 820, the network entity 804 may transmit control information 822 to indicate, to the UE 802, TPMI and rank information associated with the precoding matrix selected at 820. In some aspects, the control information 822 may be included in an uplink grant associated with (e.g., triggering) a PUSCH transmission 824. Based on the TPMI and the rank information, the UE 802 may identify the precoding matrix selected at 820 and use the selected precoding matrix to transmit the PUSCH transmission 824 to the network entity 804.

In some aspects, the partitioning of the configured set of codebooks may be updated periodically. For example, the partitioning of the configured set of codebooks may be updated periodically to adapt to change in power consumption, local antenna blockage, or channel estimation associated with the UE 802. In some aspects, the partitioning of the configured set of codebooks may be updated aperiodically based on a change in power consumption, local antenna blockage, or channel estimation associated with the UE 802. As illustrated in FIG. 8, to update the partitioning of the configured set of codebooks, the UE 802 may determine codebook partition at 826 to update the codebook partition. In some aspects, the UE 802 may determine codebook partition and recommended subset of codebooks at 826 based on the UE's local antenna blockage, the UE's power consumption, or the UE's DL channel measurement. After determining the codebook partition at 826, the UE 802 may transmit information indicative of the updated codebook partition 830 to the network entity 804 (e.g., via MAC-CE, RRC signaling, or control information). In some aspects, as illustrated in FIG. 8, based on the updated codebook partition 830, the subset 840A, the subset 840B, the subset 840C, or the subset 840D may be changed. In some aspects, the recommended subset may still be the subset 840A.

In some aspects, the network entity 804 may determine codebook partition and recommended subset of codebooks at 828. In some aspects, the network entity 804 may determine codebook partition and recommended subset of codebooks at 828 based on PUSCH decoding results (e.g., including PUSCH decoding result associated with PUSCH transmission 824 and one or more other PUSCH decoding results). In some aspects, by way of example, based on a machine learning model, the network entity 804 may learn which precoder(s) may be suitable for the UE 802. In some aspects, the network entity 804 may determine codebook partition and recommended subset of codebooks at 826 based on one or more other parameters. In some aspects, after determining codebook partition and recommended subset of codebooks at 828, the network entity 804 may transmit information indicative of the updated codebook partition 832 to the UE 802 (e.g., via MAC-CE, RRC signaling, or control information). In some aspects, as illustrated in FIG. 8, based on the codebook partition 832, the subset 840A, the subset 840B, the subset 840C, or the subset 840D may be changed. In some aspects, the recommended subset may still be the subset 840A.

In some aspects, the network entity 804 may further select precoding matrix within the recommended subset based on the updated partition. In some aspects, the network entity 804 may transmit control information to indicate, to the UE 802, TPMI and rank information associated with the precoding matrix selected based on the updated partition. In some aspects, the control information may be included in an uplink grant associated with (e.g., triggering) a second PUSCH transmission. Based on the TPMI and the rank information, the UE 802 may identify the selected precoding matrix and use the selected precoding matrix to transmit the second PUSCH transmission to the network entity.

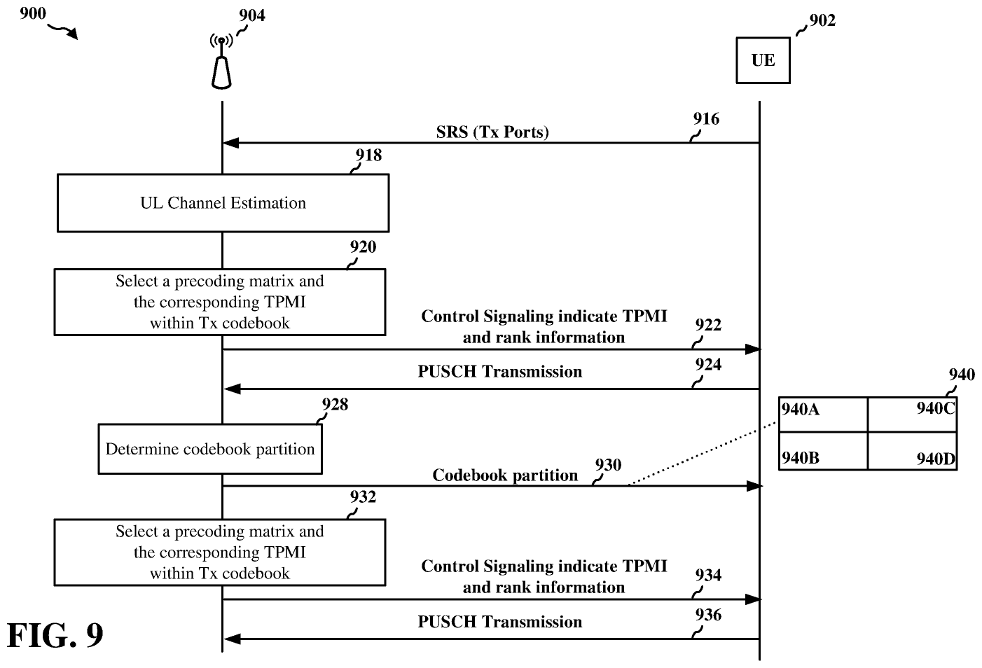

FIG. 9 is a diagram 900 illustrating example communications between a network entity 904 and a UE 902. The network entity 904 may be a network node. A network node may be implemented as an aggregated base station, a disaggregated base station, an integrated access and backhaul (IAB) node, a relay node, a sidelink node, or the like. A network entity can be implemented in an aggregated or monolithic base station architecture, or alternatively, in a disaggregated base station architecture, and may include one or more of a CU, a DU, a RU, a Near-Real Time (Near-RT) RAN Intelligent Controller (RIC), or a Non-Real Time (Non-RT) RIC.

As illustrated in FIG. 9, the UE 902 may transmit one or more SRS 916 to the network entity 904. Based on the one or more SRS 916, the network entity 904 may perform channel estimation at 918. For example, the one or more SRS 916 may be used by the network entity 904 to estimate the quality of the uplink channel for large bandwidths outside the assigned span to the UE 902. The one or more SRS 916 may be generated using a base sequence that may have small power variations in time and frequency, which may result in high power amplifier efficiency and comparable channel estimation quality for all frequency components. In some aspects, the uplink channel may be denoted by Ĥ_{UL}. In some aspects, the uplink channel may be estimated based on Rx and Tx (e.g., Rx×Tx) associated with the one or more SRS 916. After performing the channel estimation at 918, in some aspects, at 920, the network entity 904 may select a precoding matrix and the corresponding TPMI from the configured set of codebooks. In some aspects, the precoding matrix selected at 920 may be different per each PUSCH transmission or per each slot.

After selecting the precoding matrix and the corresponding TPMI at 920, the network entity 904 may transmit control information 922 to indicate, to the UE 902, TPMI and rank information associated with the precoding matrix selected at 920. In some aspects, the control information 922 may be included in an uplink grant associated with (e.g., triggering) a PUSCH transmission 924. Based on the TPMI and the rank information, the UE 902 may identify the precoding matrix selected at 920 and use the selected precoding matrix to transmit the PUSCH transmission 924 to the network entity 904.

In some aspects, the network entity 904 may determine codebook partition and recommended subset of codebooks at 928. In some aspects, the network entity 904 may determine codebook partition and recommended subset of codebooks at 928 based on PUSCH decoding results (e.g., including PUSCH decoding result associated with PUSCH transmission 924 and one or more other PUSCH decoding results). In some aspects, by way of example, based on a machine learning model, the network entity 904 may learn which precoder(s) may be suitable for the UE 902. In some aspects, the network entity 904 may determine codebook partition and recommended subset of codebooks at 928 based on one or more other parameters. In some aspects, after determining codebook partition and recommended subset of codebooks at 928, the network entity 904 may transmit information indicative of the codebook partition 930 along with information indicative of a recommended subset of codebooks to the UE 802 (e.g., via MAC-CE, RRC signaling, or control information).

In some aspects, as illustrated in FIG. 9, based on the codebook partition 930, a configured set of codebooks 940 may be partitioned into a first subset 940A, a second subset 940B, a third subset 940C, and a fourth subset 940D. As an example, the recommended subset of codebooks may be the subset 940A.

In some aspects, at 932, the network entity 904 may select a precoding matrix and the corresponding TPMI from the recommended subset of codebooks based on the codebook partitioning 930. In some aspects, the precoding matrix selected at 932 may be different per each PUSCH transmission or per each slot.

After selecting the precoding matrix and the corresponding TPMI from the recommended subset of codebooks based on the codebook partitioning 930 at 932, the network entity 904 may transmit control information 934 to indicate, to the UE 902, TPMI and rank information associated with the precoding matrix selected at 820. In some aspects, the control information 934 may be included in an uplink grant associated with (e.g., triggering) a PUSCH transmission 936. Based on the TPMI and the rank information, the UE 002 may identify the precoding matrix selected at 932 and use the selected precoding matrix to transmit the PUSCH transmission 936 to the network entity 904. In some aspects, the codebook partitioning may be updated periodically or aperiodically by the network entity 904. In some aspects, the network entity 904 may further select precoding matrix within the recommended subset based on the updated partition. In some aspects, the network entity 904 may transmit control information to indicate, to the UE 902, TPMI and rank information associated with the precoding matrix selected based on the updated partition. In some aspects, the control information may be included in an uplink grant associated with (e.g., triggering) a second PUSCH transmission. Based on the TPMI and the rank information, the UE 902 may identify the selected precoding matrix and use the selected precoding matrix to transmit the second PUSCH transmission to the network entity.

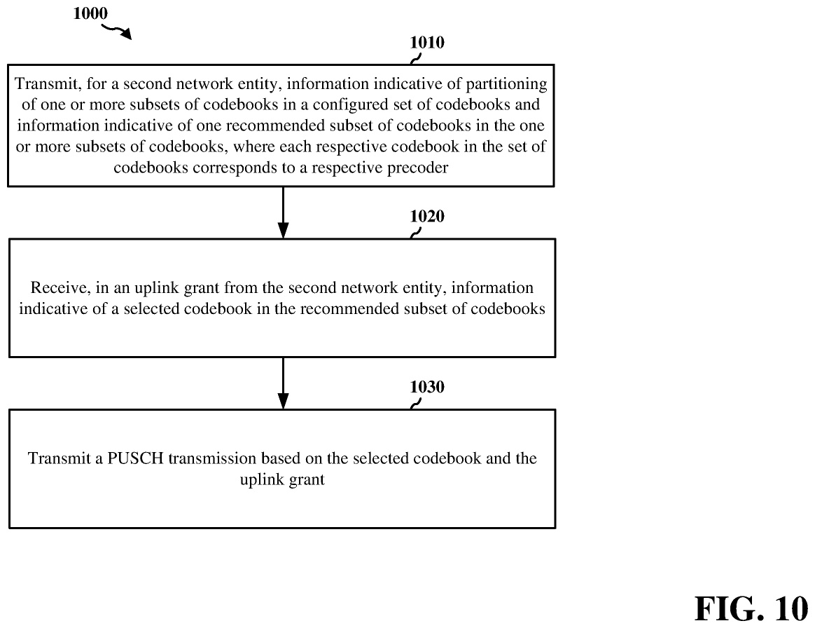

FIG. 10 is a flowchart 1000 of a method of wireless communication. The method may be performed by a first network entity (e.g., the UE 104, the UE 802; the apparatus 1804).

At 1010, the first network entity may transmit, for a second network entity, information indicative of partitioning of one or more subsets of codebooks in a configured set of codebooks and information indicative of one recommended subset of codebooks in the one or more subsets of codebooks, where each respective codebook in the set of codebooks corresponds to a respective precoder. For example, the UE 802 may transmit, for a second network entity 804, information indicative of partitioning of one or more subsets of codebooks in a configured set of codebooks and information indicative of one recommended subset of codebooks in the one or more subsets of codebooks (e.g., 806 and 808), where each respective codebook in the set of codebooks corresponds to a respective precoder. In some aspects, 1010 may be performed by codebook component 198.

At 1020, the first network entity may receive, in an uplink grant from the second network entity, information indicative of a selected codebook in the recommended subset of codebooks. For example, the UE 802 may receive, in an uplink grant from the second network entity, information (e.g., 822) indicative of a selected codebook in the recommended subset of codebooks. In some aspects, 1020 may be performed by codebook component 198.

At 1030, the first network entity may transmit a PUSCH transmission based on the selected codebook and the uplink grant. For example, the UE 802 may transmit a PUSCH transmission (e.g., 824) based on the selected codebook and the uplink grant. In some aspects, 1030 may be performed by codebook component 198.

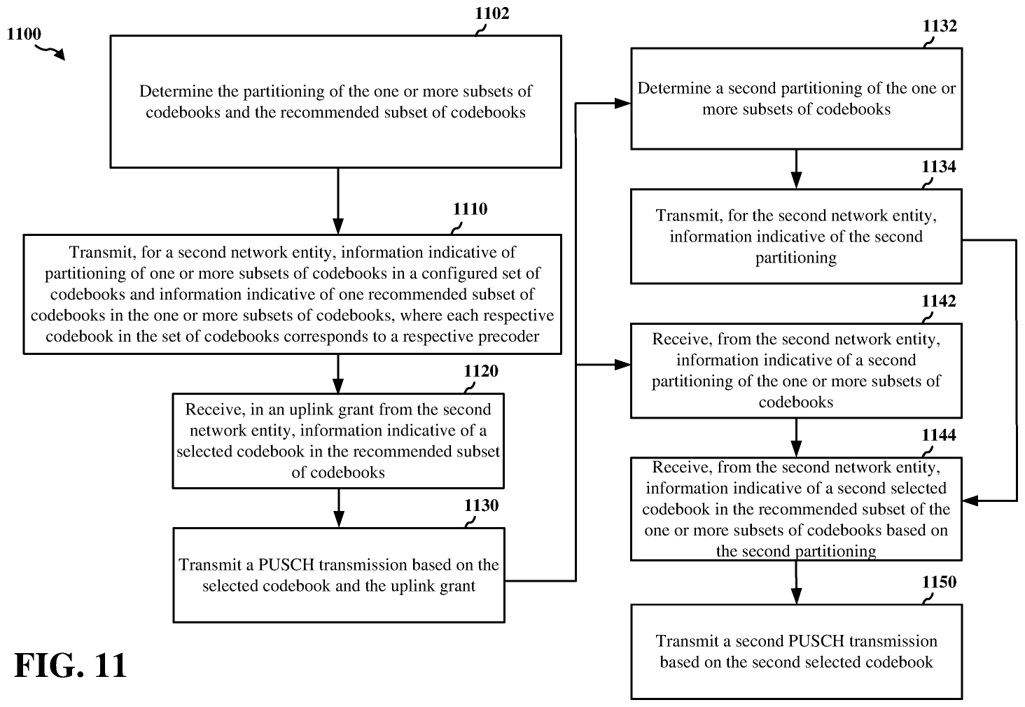

FIG. 11 is a flowchart 1100 of a method of wireless communication. The method may be performed by a first network entity (e.g., the UE 104, the UE 802; the apparatus 1804).

At 1102, the first network entity may determine the partitioning of the one or more subsets of codebooks and the recommended subset of codebooks. For example, the UE 802 may determine the partitioning of the one or more subsets of codebooks and the recommended subset of codebooks at 804. In some aspects, 1102 may be performed by codebook component 198. In some aspects, the first network entity may determine the partitioning of the one or more subsets of codebooks and the recommended subset of codebooks based on an antenna layout associated with the first network entity. In some aspects, to determine the partitioning of the one or more subsets of codebooks and the recommended subset of codebooks, the first network entity may also determine the partitioning of the one or more subsets of codebooks and the recommended subset of codebooks based on at least one of: a local antenna blockage associated with the first network entity, a power consumption associated with the first network entity, or a channel measurement associated with the first network entity.

At 1110, the first network entity may transmit, for a second network entity, information indicative of partitioning of one or more subsets of codebooks in a configured set of codebooks and information indicative of one recommended subset of codebooks in the one or more subsets of codebooks, where each respective codebook in the set of codebooks corresponds to a respective precoder. For example, the UE 802 may transmit, for a second network entity 804, information indicative of partitioning of one or more subsets of codebooks in a configured set of codebooks and information indicative of one recommended subset of codebooks in the one or more subsets of codebooks (e.g., 806 and 808), where each respective codebook in the set of codebooks corresponds to a respective precoder. In some aspects, 1110 may be performed by codebook component 198. In some aspects, to transmit the information indicative of the partitioning, the first network entity may transmit uplink control information (UCI) or radio resource control (RRC) signaling including the information indicative of the partitioning, where the RRC signaling further includes capability information associated with the first network entity. In some aspects, to transmit the information indicative of the partitioning, the first network entity may transmit an uplink medium access control (MAC) control element (MAC-CE) including the information indicative of the partitioning.

At 1120, the first network entity may receive, in an uplink grant from the second network entity, information indicative of a selected codebook in the recommended subset of codebooks. For example, the UE 802 may receive, in an uplink grant from the second network entity, information (e.g., 822) indicative of a selected codebook in the recommended subset of codebooks. In some aspects, 1120 may be performed by codebook component 198.

At 1130, the first network entity may transmit a PUSCH transmission based on the selected codebook and the uplink grant. For example, the UE 802 may transmit a PUSCH transmission (e.g., 824) based on the selected codebook and the uplink grant. In some aspects, 1130 may be performed by codebook component 198.

At 1132, the first network entity may determine a second partitioning of the one or more subsets of codebooks. For example, the UE 802 may determine a second partitioning of the one or more subsets of codebooks at 826. In some aspects, 1132 may be performed by codebook component 198. In some aspects, the first network entity may determine a second partitioning of the one or more subsets of codebooks based on at least one of: a local antenna blockage associated with the first network entity, a power consumption associated with the first network entity, or a channel measurement associated with the first network entity.

At 1134, the first network entity may transmit, for the second network entity, information indicative of the second partitioning. For example, the UE 802 may transmit, for the second network entity, information indicative of the second partitioning (e.g., 830). In some aspects, 1134 may be performed by codebook component 198.

At 1142, the first network entity may receive, from the second network entity, information indicative of a second partitioning of the one or more subsets of codebooks. For example, the UE 802 may receive, from the second network entity, information indicative of a second partitioning of the one or more subsets of codebooks (e.g., 832). In some aspects, 1142 may be performed by codebook component 198. In some aspects, the second partitioning is based on at least a decoding result associated with the first PUSCH transmission.

At 1144, the first network entity may receive, from the second network entity, information indicative of a second selected codebook in the recommended subset of the one or more subsets of codebooks based on the second partitioning. For example, the UE 802 may receive, from the second network entity, information indicative of a second selected codebook in the recommended subset of the one or more subsets of codebooks based on the second partitioning. In some aspects, 1144 may be performed by codebook component 198.

At 1150, the first network entity may transmit a second PUSCH transmission based on the second selected codebook. For example, the UE 802 may transmit a second PUSCH transmission based on the second selected codebook. In some aspects, 1150 may be performed by codebook component 198.

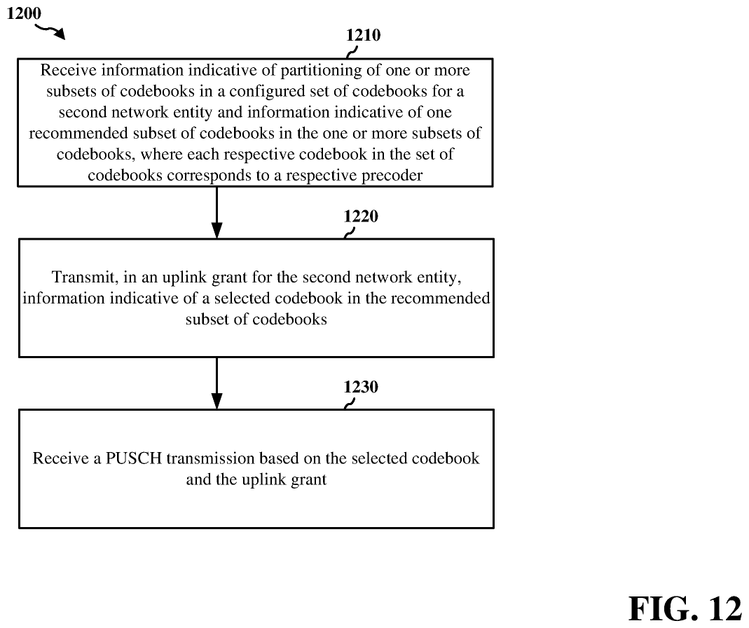

FIG. 12 is a flowchart 1200 of a method of wireless communication. The method may be performed by a network entity (e.g., the base station 102, the network entity 804, the network entity 1802, the network entity 1902).

At 1210, the first network entity may receive information indicative of partitioning of one or more subsets of codebooks in a configured set of codebooks for a second network entity (e.g., UE 802) and information indicative of one recommended subset of codebooks in the one or more subsets of codebooks, where each respective codebook in the set of codebooks corresponds to a respective precoder. For example, the network entity 804 may receive information indicative of partitioning of one or more subsets of codebooks in a configured set of codebooks for a second network entity and information indicative of one recommended subset of codebooks in the one or more subsets of codebooks (e.g., 806 and 808), where each respective codebook in the set of codebooks corresponds to a respective precoder. In some aspects, 1210 may be performed by codebook component 199.

At 1220, the first network entity may transmit, in an uplink grant for the second network entity, information indicative of a selected codebook in the recommended subset of codebooks (e.g., 822). For example, the network entity 804 may transmit, in an uplink grant for the second network entity, information indicative of a selected codebook in the recommended subset of codebooks. In some aspects, 1220 may be performed by codebook component 199.

At 1230, the first network entity may receive a PUSCH transmission based on the selected codebook and the uplink grant. For example, the network entity 804 may receive a PUSCH transmission (e.g., 824) based on the selected codebook and the uplink grant. In some aspects, 1230 may be performed by codebook component 199.

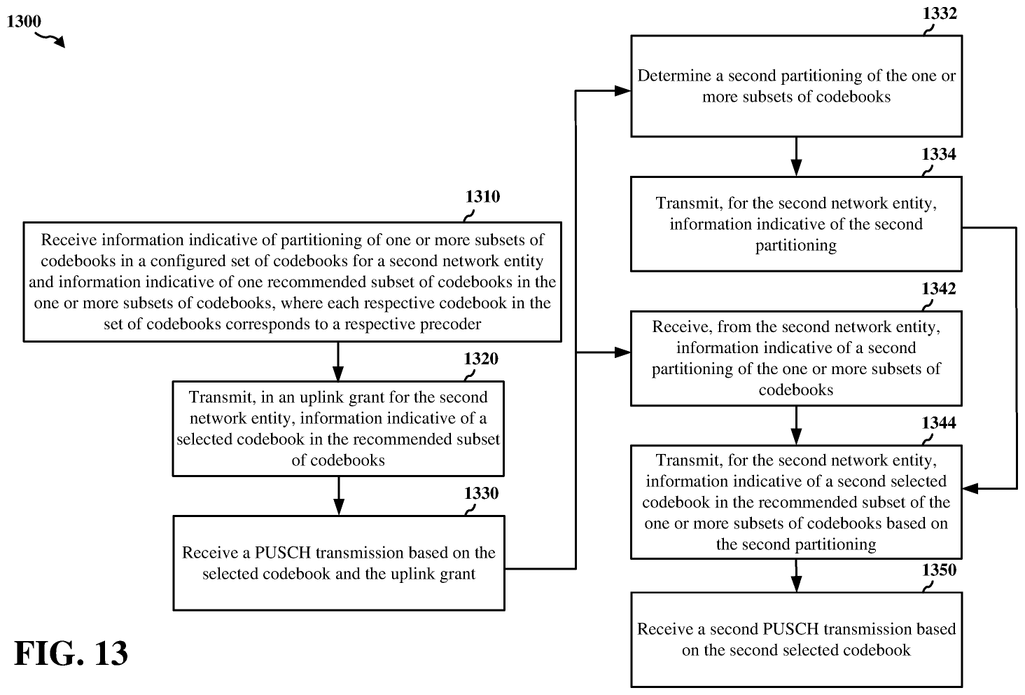

FIG. 13 is a flowchart 1300 of a method of wireless communication. The method may be performed by a network entity (e.g., the base station 102, the network entity 804, the network entity 1802, the network entity 1902).

At 1310, the first network entity may receive information indicative of partitioning of one or more subsets of codebooks in a configured set of codebooks for a second network entity and information indicative of one recommended subset of codebooks in the one or more subsets of codebooks, where each respective codebook in the set of codebooks corresponds to a respective precoder. For example, the network entity 804 may receive information indicative of partitioning of one or more subsets of codebooks in a configured set of codebooks for a second network entity (e.g., UE 804) and information indicative of one recommended subset of codebooks in the one or more subsets of codebooks (e.g., 806 and 808), where each respective codebook in the set of codebooks corresponds to a respective precoder. In some aspects, 1310 may be performed by codebook component 199. In some aspects, the partitioning of the one or more subsets of codebooks and the recommended subset of codebooks are based on an antenna layout associated with the second network entity. In some aspects, the partitioning of the one or more subsets of codebooks and the recommended subset of codebooks are based on at least one of a local antenna blockage associated with the second network entity, a power consumption associated with the second network entity, or a channel measurement associated with the second network entity. In some aspects, to receive the information indicative of the partitioning, the first network entity may receive an uplink medium access control (MAC) control element (MAC-CE) including the information indicative of the partitioning. In some aspects, to receive the information indicative of the partitioning, the first network entity may receive uplink control information (UCI) or radio resource control (RRC) signaling including the information indicative of the partitioning, where the RRC signaling further includes capability information associated with the second network entity.

At 1320, the first network entity may transmit, in an uplink grant for the second network entity, information indicative of a selected codebook in the recommended subset of codebooks (e.g., 822). For example, the network entity 804 may transmit, in an uplink grant for the second network entity, information indicative of a selected codebook in the recommended subset of codebooks. In some aspects, 1320 may be performed by codebook component 199.

At 1330, the first network entity may receive a PUSCH transmission based on the selected codebook and the uplink grant. For example, the network entity 804 may receive a PUSCH transmission (e.g., 824) based on the selected codebook and the uplink grant. In some aspects, 1330 may be performed by codebook component 199.

At 1332, the first network entity may determine a second partitioning of the one or more subsets of codebooks. For example, the network entity 804 may determine a second partitioning of the one or more subsets of codebooks (e.g., at 828). In some aspects, 1332 may be performed by codebook component 199. In some aspects, to determine the second partitioning, the first network entity may determine the second partitioning based on at least a decoding result associated with the first PUSCH transmission and a machine learning model.

At 1334, the first network entity may transmit information indicative of the second partitioning of the one or more subsets of codebooks. For example, the network entity 804 may transmit information indicative of the second partitioning of the one or more subsets of codebooks (e.g., 832). In some aspects, 1334 may be performed by codebook component 199.

At 1342, the first network entity may receive information indicative of a second partitioning of the one or more subsets of codebooks. For example, the network entity 804 may receive information indicative of a second partitioning of the one or more subsets of codebooks (e.g., 830). In some aspects, 1342 may be performed by codebook component 199. In some aspects, the second partitioning is based on at least one of a local antenna blockage associated with the second network entity, a power consumption associated with the second network entity, or a channel measurement associated with the second network entity.

At 1344, the first network entity may transmit, for the second network entity, information indicative of a second selected codebook in the recommended subset of the one or more subsets of codebooks based on the second partitioning. For example, the network entity 804 may transmit, for the second network entity, information indicative of a second selected codebook in the recommended subset of the one or more subsets of codebooks based on the second partitioning. In some aspects, 1344 may be performed by codebook component 199.

At 1350, the first network entity may receive a second PUSCH transmission based on the second selected codebook. For example, the network entity 804 may receive a second PUSCH transmission based on the second selected codebook. In some aspects, 1350 may be performed by codebook component 199.

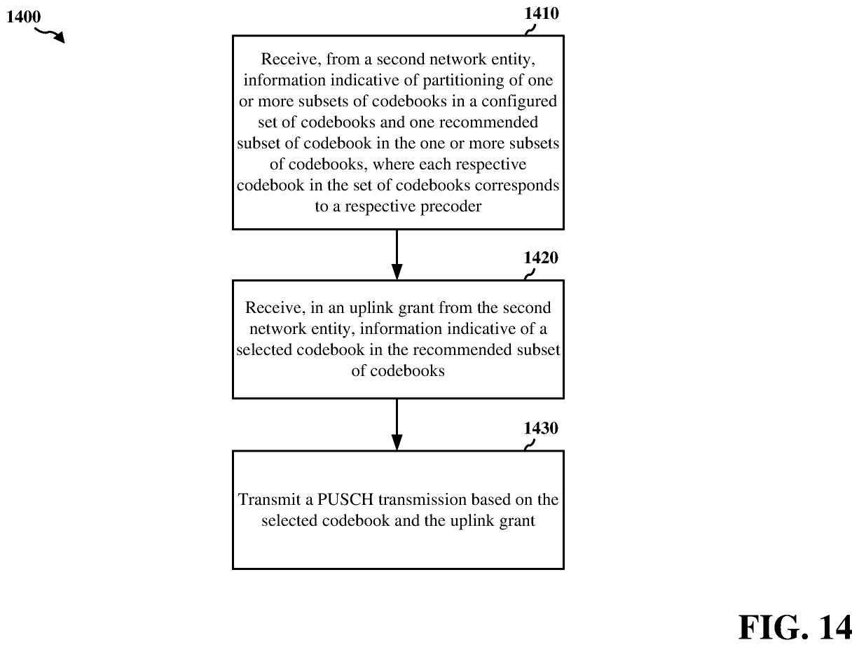

FIG. 14 is a flowchart 1400 of a method of wireless communication. The method may be performed by a first network entity (e.g., the UE 104, the UE 902; the apparatus 1804).

At 1410, the first network entity may receive, from a second network entity, information indicative of partitioning of one or more subsets of codebooks in a configured set of codebooks and one recommended subset of codebook in the one or more subsets of codebooks, where each respective codebook in the set of codebooks corresponds to a respective precoder. For example, the UE 902 may receive, from a second network entity 904, information indicative of partitioning of one or more subsets of codebooks in a configured set of codebooks and one recommended subset of codebook in the one or more subsets of codebooks (e.g., 930), where each respective codebook in the set of codebooks corresponds to a respective precoder. In some aspects, 1410 may be performed by codebook component 198.

At 1420, the first network entity may receive, in an uplink grant from the second network entity, information indicative of a selected codebook in the recommended subset of codebooks. For example, the UE 902 may receive, in an uplink grant from the second network entity, information indicative of a selected codebook in the recommended subset of codebooks (e.g., 934). In some aspects, 1420 may be performed by codebook component 198.

At 1430, the first network entity may transmit a PUSCH transmission based on the selected codebook and the uplink grant. For example, the UE 902 may transmit a PUSCH transmission (e.g., 936) based on the selected codebook and the uplink grant. In some aspects, 1430 may be performed by codebook component 198.

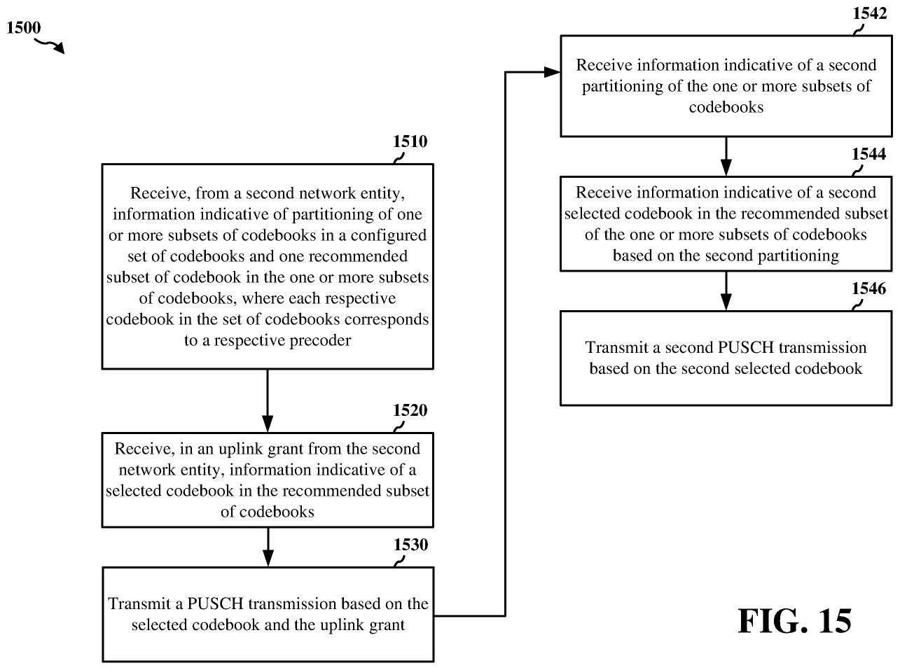

FIG. 15 is a flowchart 1500 of a method of wireless communication. The method may be performed by a first network entity (e.g., the UE 104, the UE 902; the apparatus 1804).

At 1510, the first network entity may receive, from a second network entity, information indicative of partitioning of one or more subsets of codebooks in a configured set of codebooks and one recommended subset of codebook in the one or more subsets of codebooks, where each respective codebook in the set of codebooks corresponds to a respective precoder. For example, the UE 902 may receive, from a second network entity 904, information indicative of partitioning of one or more subsets of codebooks in a configured set of codebooks and one recommended subset of codebook in the one or more subsets of codebooks (e.g., 930), where each respective codebook in the set of codebooks corresponds to a respective precoder. In some aspects, 1510 may be performed by codebook component 198. In some aspects, to receive the information indicative of the partitioning, the first network entity may receive a downlink medium access control (MAC) control element (MAC-CE) including the information indicative of the partitioning. In some aspects, to receive the information indicative of the partitioning, the first network entity may downlink control information (DCI) or radio resource control (RRC) signaling including the information indicative of the partitioning.

At 1520, the first network entity may receive, in an uplink grant from the second network entity, information indicative of a selected codebook in the recommended subset of codebooks. For example, the UE 902 may receive, in an uplink grant from the second network entity, information indicative of a selected codebook in the recommended subset of codebooks (e.g., 934). In some aspects, 1520 may be performed by codebook component 198.

At 1530, the first network entity may transmit a PUSCH transmission based on the selected codebook and the uplink grant. For example, the UE 902 may transmit a PUSCH transmission (e.g., 936) based on the selected codebook and the uplink grant. In some aspects, 1530 may be performed by codebook component 198.

At 1542, the first network entity may receive information indicative of a second partitioning of the one or more subsets of codebooks. For example, the UE 902 may receive information indicative of a second partitioning of the one or more subsets of codebooks. In some aspects, 1542 may be performed by codebook component 198.

At 1544, the first network entity may receive information indicative of a second selected codebook in the recommended subset of the one or more subsets of codebooks based on the second partitioning. For example, the UE 902 may receive information indicative of a second selected codebook in the recommended subset of the one or more subsets of codebooks based on the second partitioning. In some aspects, 1544 may be performed by codebook component 198.

At 1546, the first network entity may transmit a second PUSCH transmission based on the second selected codebook. For example, the UE 902 may transmit a second PUSCH transmission based on the second selected codebook. In some aspects, 1546 may be performed by codebook component 198.

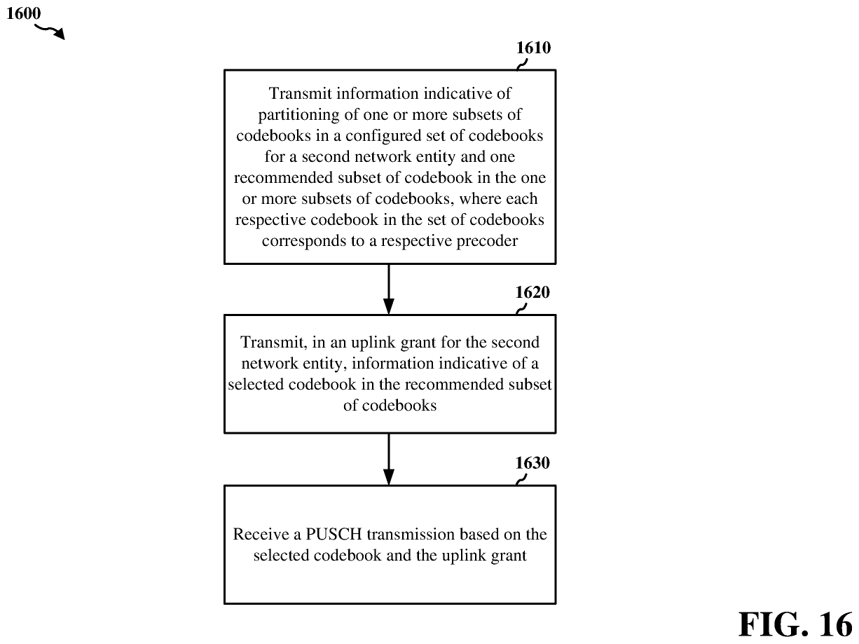

FIG. 16 is a flowchart 1600 of a method of wireless communication. The method may be performed by a network entity (e.g., the base station 102, the network entity 904, the network entity 1802, the network entity 1902).

At 1610, the first network entity may transmit information indicative of partitioning of one or more subsets of codebooks in a configured set of codebooks for a second network entity and one recommended subset of codebook in the one or more subsets of codebooks, where each respective codebook in the set of codebooks corresponds to a respective precoder. For example, the network entity 904 may transmit information indicative of partitioning of one or more subsets of codebooks in a configured set of codebooks for a second network entity (e.g., UE 902) and one recommended subset of codebook in the one or more subsets of codebooks (e.g., 930), where each respective codebook in the set of codebooks corresponds to a respective precoder. In some aspects, 1610 may be performed by codebook component 199.

At 1620, the first network entity may transmit, in an uplink grant for the second network entity, information indicative of a selected codebook in the recommended subset of codebooks. For example, the network entity 904 may transmit, in an uplink grant for the second network entity, information indicative of a selected codebook in the recommended subset of codebooks (e.g., 934). In some aspects, 1620 may be performed by codebook component 199.

At 1630, the first network entity may receive a PUSCH transmission based on the selected codebook and the uplink grant. For example, the network entity 904 may receive a PUSCH transmission based on the selected codebook and the uplink grant (e.g., 936). In some aspects, 1630 may be performed by codebook component 199.

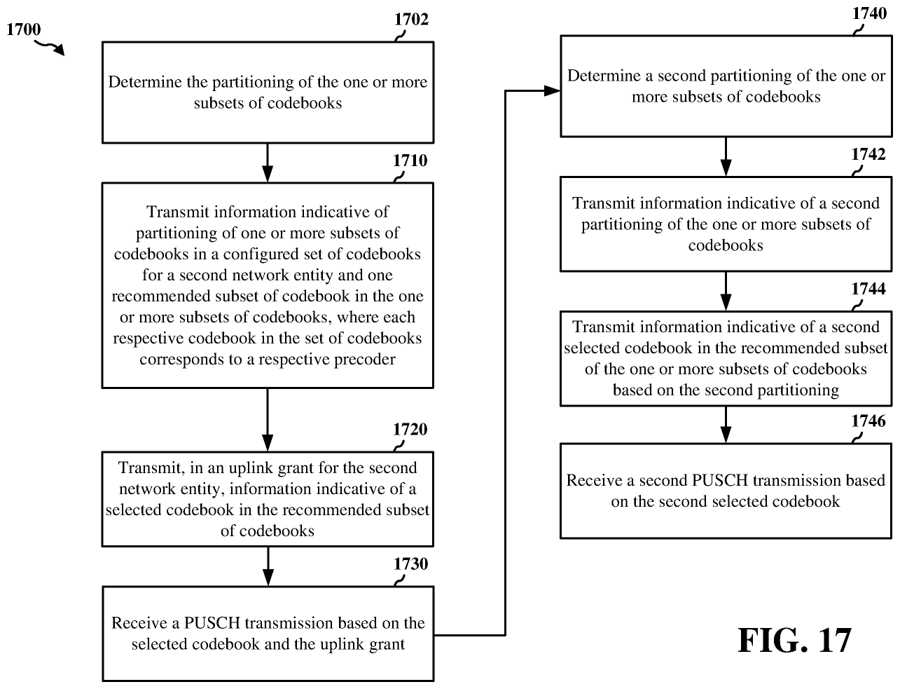

FIG. 17 is a flowchart 1700 of a method of wireless communication. The method may be performed by a network entity (e.g., the base station 102, the network entity 904, the network entity 1802, the network entity 1902).

At 1702, the first network entity may determine the partitioning of the one or more subsets of codebooks. For example, the network entity 904 may determine the partitioning of the one or more subsets of codebooks (e.g., at 928). In some aspects, 1702 may be performed by codebook component 199.

At 1710, the first network entity may transmit information indicative of partitioning of one or more subsets of codebooks in a configured set of codebooks for a second network entity and one recommended subset of codebook in the one or more subsets of codebooks, where each respective codebook in the set of codebooks corresponds to a respective precoder. For example, the network entity 904 may transmit information indicative of partitioning of one or more subsets of codebooks in a configured set of codebooks for a second network entity (e.g., UE 902) and one recommended subset of codebook in the one or more subsets of codebooks (e.g., 930), where each respective codebook in the set of codebooks corresponds to a respective precoder. In some aspects, 1710 may be performed by codebook component 199. In some aspects, to transmit the information indicative of the partitioning, the first network entity may transmit a downlink medium access control (MAC) control element (MAC-CE) including the information indicative of the partitioning. In some aspects, to transmit the information indicative of the partitioning, the first network entity may transmit downlink control information (DCI) or radio resource control (RRC) signaling including the information indicative of the partitioning.

At 1720, the first network entity may transmit, in an uplink grant for the second network entity, information indicative of a selected codebook in the recommended subset of codebooks. For example, the network entity 904 may transmit, in an uplink grant for the second network entity, information indicative of a selected codebook in the recommended subset of codebooks (e.g., 934). In some aspects, 1720 may be performed by codebook component 199.

At 1730, the first network entity may receive a PUSCH transmission based on the selected codebook and the uplink grant. For example, the network entity 904 may receive a PUSCH transmission based on the selected codebook and the uplink grant (e.g., 936). In some aspects, 1730 may be performed by codebook component 199.

At 1740, the first network entity may determine a second partitioning of the one or more subsets of codebooks. For example, the network entity 904 may determine a second partitioning of the one or more subsets of codebooks. In some aspects, 1740 may be performed by codebook component 199. In some aspects, to determine the second partitioning, the first network entity may determine the second partitioning based on at least a set of PUSCH decoding results including a PUSCH decoding result associated with the PUSCH transmission.

At 1742, the first network entity may transmit information indicative of a second partitioning of the one or more subsets of codebooks. For example, the network entity 904 may transmit information indicative of a second partitioning of the one or more subsets of codebooks. In some aspects, 1742 may be performed by codebook component 199.

At 1744, the first network entity may transmit information indicative of a second selected codebook in the recommended subset of the one or more subsets of codebooks based on the second partitioning. For example, the network entity 904 may transmit information indicative of a second selected codebook in the recommended subset of the one or more subsets of codebooks based on the second partitioning. In some aspects, 1744 may be performed by codebook component 199.

At 1746, the first network entity may receive a second PUSCH transmission based on the second selected codebook. For example, the network entity 904 may receive a second PUSCH transmission based on the second selected codebook. In some aspects, 1746 may be performed by codebook component 199.

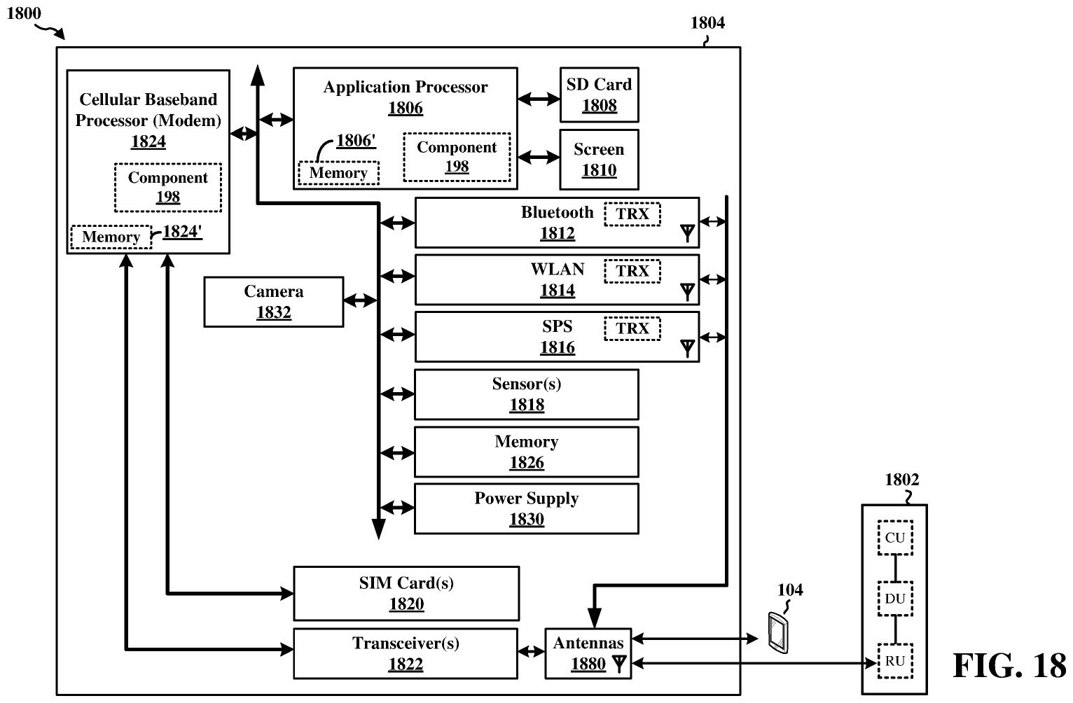

FIG. 18 is a diagram 1800 illustrating an example of a hardware implementation for an apparatus 1804. The apparatus 1804 may be a UE, a component of a UE, or may implement UE functionality. In some aspects, the apparatus 1804 may include a cellular baseband processor 1824 (also referred to as a modem) coupled to one or more transceivers 1822 (e.g., cellular RF transceiver). The cellular baseband processor 1824 may include on-chip memory 1824′. In some aspects, the apparatus 1804 may further include one or more subscriber identity modules (SIM) cards 1820 and an application processor 1806 coupled to a secure digital (SD) card 1808 and a screen 1810. The application processor 1806 may include on-chip memory 1806′. In some aspects, the apparatus 1804 may further include a Bluetooth module 1812, a WLAN module 1814, a satellite system module 1816 (e.g., GNSS module), one or more sensor modules 1818 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1826, a power supply 1830, and/or a camera 1832. The Bluetooth module 1812, the WLAN module 1814, and the satellite system module 1816 may include an on-chip transceiver (TRX)/receiver (RX). The cellular baseband processor 1824 communicates through the transceiver(s) 1822 via one or more antennas 1880 with the UE 104 and/or with an RU associated with a network entity 1802. The cellular baseband processor 1824 and the application processor 1806 may each include a computer-readable medium/memory 1824′, 1806′, respectively. The additional memory modules 1826 may also be considered a computer-readable medium/memory. Each computer-readable medium/memory 1824′, 1806′, 1826 may be non-transitory. The cellular baseband processor 1824 and the application processor 1806 are each responsible for general processing, including the execution of software stored on the computer-readable medium/memory. The software, when executed by the cellular baseband processor 1824/application processor 1806, causes the cellular baseband processor 1824/application processor 1806 to perform the various functions described herein. The computer-readable medium/memory may also be used for storing data that is manipulated by the cellular baseband processor 1824/application processor 1806 when executing software. The cellular baseband processor 1824/application processor 1806 may be a component of the UE 350 and may include the memory 360 and/or at least one of the TX processor 368, the RX processor 356, and the controller/processor 359. In one configuration, the apparatus 1804 may be a processor chip (modem and/or application) and include just the cellular baseband processor 1824 and/or the application processor 1806, and in another configuration, the apparatus 1804 may be the entire UE (e.g., see 350 of FIG. 3) and include the additional modules of the apparatus 1804.

In some aspects, the codebook component 198 may be configured to transmit, for a second network entity, information indicative of partitioning of one or more subsets of codebooks in a configured set of codebooks and information indicative of one recommended subset of codebooks in the one or more subsets of codebooks, where each respective codebook in the set of codebooks corresponds to a respective precoder. In some aspects, the codebook component 198 may be configured to receive, in an uplink grant from the second network entity, information indicative of a selected codebook in the recommended subset of codebooks. In some aspects, the codebook component 198 may be configured to transmit a PUSCH transmission based on the selected codebook and the uplink grant. In some aspects, the codebook component 198 may be configured to receive, from a second network entity, information indicative of partitioning of one or more subsets of codebooks in a configured set of codebooks and one recommended subset of codebook in the one or more subsets of codebooks, where each respective codebook in the set of codebooks corresponds to a respective precoder. In some aspects, the codebook component 198 may be configured to receive, in an uplink grant from the second network entity, information indicative of a selected codebook in the recommended subset of codebooks. In some aspects, the codebook component 198 may be configured to transmit a PUSCH transmission based on the selected codebook and the uplink grant. The codebook component 198 may be within the cellular baseband processor 1824, the application processor 1806, or both the cellular baseband processor 1824 and the application processor 1806. The codebook component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1804 may include a variety of components configured for various functions. In one configuration, the apparatus 1804, and in particular the cellular baseband processor 1824 and/or the application processor 1806, includes means for transmitting, for a second network entity, information indicative of partitioning of one or more subsets of codebooks in a configured set of codebooks and information indicative of one recommended subset of codebooks in the one or more subsets of codebooks, where each respective codebook in the set of codebooks corresponds to a respective precoder. In some aspects, the apparatus 1804 may include means for receiving, in an uplink grant from the second network entity, information indicative of a selected codebook in the recommended subset of codebooks. In some aspects, the apparatus 1804 may further include means for transmitting a PUSCH transmission based on the selected codebook and the uplink grant. In some aspects, the apparatus 1804 may include means for determining the partitioning of the one or more subsets of codebooks and the recommended subset of codebooks based on an antenna layout associated with the first network entity. In some aspects, the apparatus 1804 may further include means for determining the partitioning of the one or more subsets of codebooks and the recommended subset of codebooks based on at least one of: a local antenna blockage associated with the first network entity, a power consumption associated with the first network entity, or a channel measurement associated with the first network entity. In some aspects, the apparatus 1804 may include means for determining a second partitioning of the one or more subsets of codebooks based on at least one of: a local antenna blockage associated with the first network entity, a power consumption associated with the first network entity, or a channel measurement associated with the first network entity. In some aspects, the apparatus 1804 may include means for transmitting, for the second network entity, information indicative of the second partitioning. In some aspects, the apparatus 1804 may include means for receiving, from the second network entity, information indicative of a second partitioning of the one or more subsets of codebooks. In some aspects, the apparatus 1804 may include means for receiving, from the second network entity, information indicative of a second selected codebook in the recommended subset of the one or more subsets of codebooks based on the second partitioning. In some aspects, the apparatus 1804 may include means for transmitting a second PUSCH transmission based on the second selected codebook. In some aspects, the apparatus 1804 may include means for receiving, from a second network entity, information indicative of partitioning of one or more subsets of codebooks in a configured set of codebooks and one recommended subset of codebook in the one or more subsets of codebooks, where each respective codebook in the set of codebooks corresponds to a respective precoder. In some aspects, the apparatus 1804 may include means for receiving, in an uplink grant from the second network entity, information indicative of a selected codebook in the recommended subset of codebooks. In some aspects, the apparatus 1804 may include means for transmitting a PUSCH transmission based on the selected codebook and the uplink grant. In some aspects, the apparatus 1804 may include means for receiving information indicative of a second partitioning of the one or more subsets of codebooks. In some aspects, the apparatus 1804 may include means for receiving information indicative of a second selected codebook in the recommended subset of the one or more subsets of codebooks based on the second partitioning. In some aspects, the apparatus 1804 may include means for transmitting a second PUSCH transmission based on the second selected codebook. The means may be the codebook component 198 of the apparatus 1804 configured to perform the functions recited by the means. As described herein, the apparatus 1804 may include the TX processor 368, the RX processor 356, and the controller/processor 359. As such, in one configuration, the means may be the TX processor 368, the RX processor 356, and/or the controller/processor 359 configured to perform the functions recited by the means.

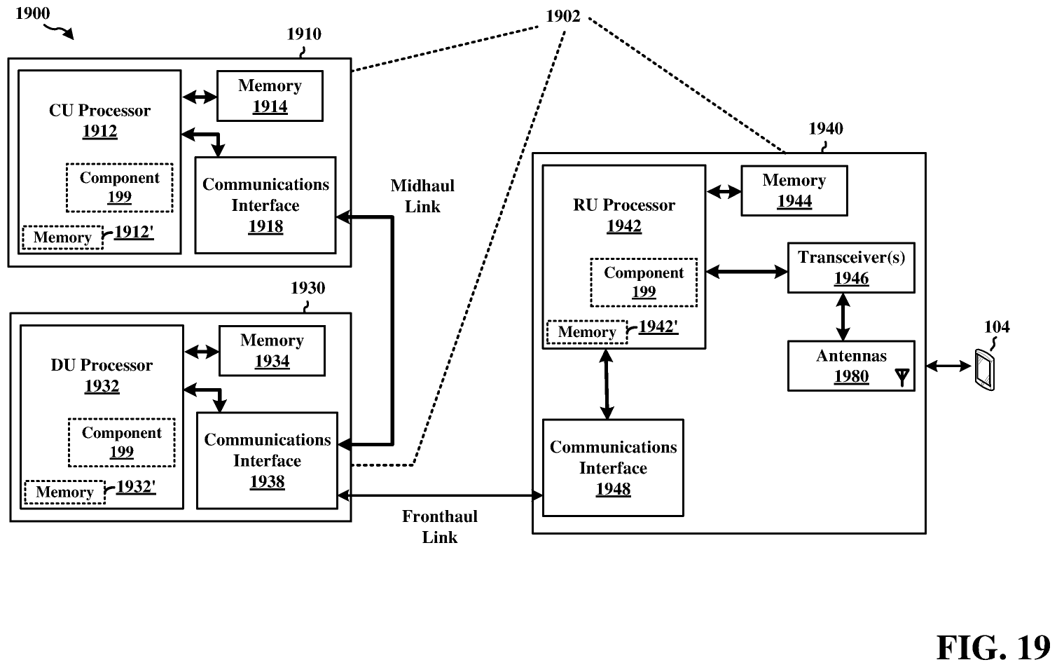

FIG. 19 is a diagram 1900 illustrating an example of a hardware implementation for a network entity 1902. The network entity 1902 may be a BS, a component of a BS, or may implement BS functionality. The network entity 1902 may include at least one of a CU 1910, a DU 1930, or an RU 1940. For example, depending on the layer functionality handled by the component 199, the network entity 1902 may include the CU 1910; both the CU 1910 and the DU 1930; each of the CU 1910, the DU 1930, and the RU 1940; the DU 1930; both the DU 1930 and the RU 1940; or the RU 1940. The CU 1910 may include a CU processor 1912. The CU processor 1912 may include on-chip memory 1912′. In some aspects, the CU 1910 may further include additional memory modules 1914 and a communications interface 1918. The CU 1910 communicates with the DU 1930 through a midhaul link, such as an F1 interface. The DU 1930 may include a DU processor 1932. The DU processor 1932 may include on-chip memory 1932′. In some aspects, the DU 1930 may further include additional memory modules 1934 and a communications interface 1938. The DU 1930 communicates with the RU 1940 through a fronthaul link. The RU 1940 may include an RU processor 1942. The RU processor 1942 may include on-chip memory 1942′. In some aspects, the RU 1940 may further include additional memory modules 1944, one or more transceivers 1946, antennas 1980, and a communications interface 1948. The RU 1940 communicates with the UE 104. The on-chip memory 1912′, 1932′, 1942′ and the additional memory modules 1914, 1934, 1944 may each be considered a computer-readable medium/memory. Each computer-readable medium/memory may be non-transitory. Each of the processors 1912, 1932, 1942 is responsible for general processing, including the execution of software stored on the computer-readable medium/memory. The software, when executed by the corresponding processor(s) causes the processor(s) to perform the various functions described herein. The computer-readable medium/memory may also be used for storing data that is manipulated by the processor(s) when executing software.

In some aspects, the codebook component 199 may be configured to receive information indicative of partitioning of one or more subsets of codebooks in a configured set of codebooks for a second network entity and information indicative of one recommended subset of codebooks in the one or more subsets of codebooks, where each respective codebook in the set of codebooks corresponds to a respective precoder. In some aspects, the codebook component 199 may be configured to transmit, in an uplink grant for the second network entity, information indicative of a selected codebook in the recommended subset of codebooks. In some aspects, the codebook component 199 may be configured to receive a PUSCH transmission based on the selected codebook and the uplink grant. In some aspects, the codebook component 199 may be configured to transmit information indicative of partitioning of one or more subsets of codebooks in a configured set of codebooks for a second network entity and one recommended subset of codebook in the one or more subsets of codebooks, where each respective codebook in the set of codebooks corresponds to a respective precoder. In some aspects, the codebook component 199 may be configured to transmit, in an uplink grant for the second network entity, information indicative of a selected codebook in the recommended subset of codebooks. In some aspects, the codebook component 199 may be configured to receive a PUSCH transmission based on the selected codebook and the uplink grant. The codebook component 199 may be within one or more processors of one or more of the CU 1910, DU 1930, and the RU 1940. The codebook component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1902 may include a variety of components configured for various functions. In one configuration, the network entity 1902 includes means for receiving information indicative of partitioning of one or more subsets of codebooks in a configured set of codebooks for a second network entity and information indicative of one recommended subset of codebooks in the one or more subsets of codebooks, where each respective codebook in the set of codebooks corresponds to a respective precoder. In some aspects, the network entity 1902 may include means for transmitting, in an uplink grant for the second network entity, information indicative of a selected codebook in the recommended subset of codebooks. In some aspects, the network entity 1902 may include means for receiving a PUSCH transmission based on the selected codebook and the uplink grant. In some aspects, the network entity 1902 may include means for receiving information indicative of a second partitioning of the one or more subsets of codebooks. In some aspects, the network entity 1902 may include means for determining a second partitioning of the one or more subsets of codebooks. In some aspects, the network entity 1902 may include means for transmitting information indicative of the second partitioning of the one or more subsets of codebooks. In some aspects, the network entity 1902 may include means for transmitting, for the second network entity, information indicative of a second selected codebook in the recommended subset of the one or more subsets of codebooks based on the second partitioning. In some aspects, the network entity 1902 may include means for receiving a second PUSCH transmission based on the second selected codebook. In some aspects, the network entity 1902 may include means for transmitting information indicative of partitioning of one or more subsets of codebooks in a configured set of codebooks for a second network entity and one recommended subset of codebook in the one or more subsets of codebooks, where each respective codebook in the set of codebooks corresponds to a respective precoder. In some aspects, the network entity 1902 may include means for transmitting, in an uplink grant for the second network entity, information indicative of a selected codebook in the recommended subset of codebooks. In some aspects, the network entity 1902 may include means for receiving a PUSCH transmission based on the selected codebook and the uplink grant. In some aspects, the network entity 1902 may include means for determining the partitioning of the one or more subsets of codebooks. In some aspects, the network entity 1902 may include means for determining a second partitioning of the one or more subsets of codebooks. In some aspects, the network entity 1902 may include means for transmit information indicative of a second partitioning of the one or more subsets of codebooks. In some aspects, the network entity 1902 may include means for transmitting information indicative of a second selected codebook in the recommended subset of the one or more subsets of codebooks based on the second partitioning. In some aspects, the network entity 1902 may include means for receiving a second PUSCH transmission based on the second selected codebook. The means may be the codebook component 199 of the network entity 1902 configured to perform the functions recited by the means. As described herein, the network entity 1902 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a first network entity for wireless communication, including: a memory; and at least one processor coupled to the memory, where the at least one processor is configured to: transmit, for a second network entity, information indicative of partitioning of one or more subsets of codebooks in a configured set of codebooks and information indicative of one recommended subset of codebooks in the one or more subsets of codebooks, where each respective codebook in the set of codebooks corresponds to a respective precoder; receive, in an uplink grant from the second network entity, information indicative of a selected codebook in the recommended subset of codebooks; and transmit a physical uplink shared channel (PUSCH) transmission based on the selected codebook and the uplink grant.

Aspect 2 is the first network of aspect 1, where the at least one processor is configured to: determine the partitioning of the one or more subsets of codebooks and the recommended subset of codebooks based on an antenna layout associated with the first network entity.

Aspect 3 is the first network of aspect 2, where to determine the partitioning of the one or more subsets of codebooks and the recommended subset of codebooks, the at least one processor is configured to determine the partitioning of the one or more subsets of codebooks and the recommended subset of codebooks based on at least one of: a local antenna blockage associated with the first network entity, a power consumption associated with the first network entity, or a channel measurement associated with the first network entity.

Aspect 4 is the first network of any of aspects 2-3, where the at least one processor is configured to: determine a second partitioning of the one or more subsets of codebooks based on at least one of: a local antenna blockage associated with the first network entity, a power consumption associated with the first network entity, or a channel measurement associated with the first network entity; and transmit, for the second network entity, information indicative of the second partitioning.

Aspect 5 is the first network entity of any of aspects 2-3, where the at least one processor is configured to: receive, from the second network entity, information indicative of a second partitioning of the one or more subsets of codebooks.

Aspect 6 is the first network of any of aspects 4-5, where the at least one processor is configured to: receive, from the second network entity, information indicative of a second selected codebook in the recommended subset of the one or more subsets of codebooks based on the second partitioning; and transmit a second PUSCH transmission based on the second selected codebook.

Aspect 7 is the first network of any of aspects 6, where the second partitioning is based on at least a decoding result associated with the first PUSCH transmission.

Aspect 8 is the first network of any of aspects 1-7, where to transmit the information indicative of the partitioning, the at least one processor is configured to transmit an uplink medium access control (MAC) control element (MAC-CE) including the information indicative of the partitioning.

Aspect 9 is the first network of any of aspects 1-8, where to transmit the information indicative of the partitioning, the at least one processor is configured to transmit uplink control information (UCI) or radio resource control (RRC) signaling including the information indicative of the partitioning, where the RRC signaling further includes capability information associated with the first network entity.

Aspect 10 is a first network entity for wireless communication, including: a memory; and at least one processor coupled to the memory, where the at least one processor is configured to: receive information indicative of partitioning of one or more subsets of codebooks in a configured set of codebooks for a second network entity and information indicative of one recommended subset of codebooks in the one or more subsets of codebooks, where each respective codebook in the set of codebooks corresponds to a respective precoder; transmit, in an uplink grant for the second network entity, information indicative of a selected codebook in the recommended subset of codebooks; and receive a physical uplink shared channel (PUSCH) transmission based on the selected codebook and the uplink grant.

Aspect 11 is the first network of aspect 10, where the partitioning of the one or more subsets of codebooks and the recommended subset of codebooks are based on an antenna layout associated with the second network entity.

Aspect 12 is the first network of any of aspects 10-11, where the partitioning of the one or more subsets of codebooks and the recommended subset of codebooks are based on at least one of: a local antenna blockage associated with the second network entity, a power consumption associated with the second network entity, or a channel measurement associated with the second network entity.

Aspect 13 is the first network of any of aspects 10-12, where the at least one processor is configured to: receive information indicative of a second partitioning of the one or more subsets of codebooks, where the second partitioning is based on at least one of: a local antenna blockage associated with the second network entity, a power consumption associated with the second network entity, or a channel measurement associated with the second network entity.

Aspect 14 is the first network entity of any of aspects 10-12, where the at least one processor is configured to: determine a second partitioning of the one or more subsets of codebooks; and transmit information indicative of the second partitioning of the one or more subsets of codebooks.

Aspect 15 is the first network of aspect 14, where the at least one processor is configured to: transmit, for the second network entity, information indicative of a second selected codebook in the recommended subset of the one or more subsets of codebooks based on the second partitioning; and receive a second PUSCH transmission based on the second selected codebook.

Aspect 16 is the first network of aspect 15, where to determine the second partitioning, the at least one processor is configured to determine the second partitioning based on at least a decoding result associated with the first PUSCH transmission and a machine learning model.

Aspect 17 is the first network of any of aspects 10-16, where to receive the information indicative of the partitioning, the at least one processor is configured to receive an uplink medium access control (MAC) control element (MAC-CE) including the information indicative of the partitioning.

Aspect 18 is the first network of any of aspects 10-17, where to receive the information indicative of the partitioning, the at least one processor is configured to receive uplink control information (UCI) or radio resource control (RRC) signaling including the information indicative of the partitioning, where the RRC signaling further includes capability information associated with the second network entity.

Aspect 19 is a first network entity for wireless communication, including: a memory; and at least one processor coupled to the memory, where the at least one processor is configured to: receive, from a second network entity, information indicative of partitioning of one or more subsets of codebooks in a configured set of codebooks and one recommended subset of codebook in the one or more subsets of codebooks, where each respective codebook in the set of codebooks corresponds to a respective precoder; receive, in an uplink grant from the second network entity, information indicative of a selected codebook in the recommended subset of codebooks; and transmit a physical uplink shared channel (PUSCH) transmission based on the selected codebook and the uplink grant.

Aspect 20 is the first network entity of aspect 19, where the at least one processor is configured to: receive information indicative of a second partitioning of the one or more subsets of codebooks.

Aspect 21 is the first network of any of aspects 19-20, where the at least one processor is configured to: receive information indicative of a second selected codebook in the recommended subset of the one or more subsets of codebooks based on the second partitioning; and transmit a second PUSCH transmission based on the second selected codebook.

Aspect 22 is the first network of any of aspects 19-21, where to receive the information indicative of the partitioning, the at least one processor is configured to receive a downlink medium access control (MAC) control element (MAC-CE) including the information indicative of the partitioning.

Aspect 23 is the first network of any of aspects 19-22, where to receive the information indicative of the partitioning, the at least one processor is configured to receive downlink control information (DCI) or radio resource control (RRC) signaling including the information indicative of the partitioning.

Aspect 24 is a first network entity for wireless communication, including: a memory; and at least one processor coupled to the memory, where the at least one processor is configured to: transmit information indicative of partitioning of one or more subsets of codebooks in a configured set of codebooks for a second network entity and one recommended subset of codebook in the one or more subsets of codebooks, where each respective codebook in the set of codebooks corresponds to a respective precoder; transmit, in an uplink grant for the second network entity, information indicative of a selected codebook in the recommended subset of codebooks; and receive a physical uplink shared channel (PUSCH) transmission based on the selected codebook and the uplink grant.

Aspect 25 is the first network of aspect 24, where the at least one processor is configured to: determine the partitioning of the one or more subsets of codebooks.

Aspect 26 is the first network entity of any of aspects 24-25, where the at least one processor is configured to: determine a second partitioning of the one or more subsets of codebooks; and transmit information indicative of a second partitioning of the one or more subsets of codebooks.

Aspect 27 is the first network of any of aspects 24-26, where the at least one processor is configured to: transmit information indicative of a second selected codebook in the recommended subset of the one or more subsets of codebooks based on the second partitioning; and receive a second PUSCH transmission based on the second selected codebook.

Aspect 28 is the first network of any of aspects 24-27, where to determine the second partitioning, the at least one processor is configured to: determine the second partitioning based on at least a set of PUSCH decoding results including a PUSCH decoding result associated with the PUSCH transmission.

Aspect 29 is the first network of any of aspects 24-28, where to transmit the information indicative of the partitioning, the at least one processor is configured to transmit a downlink medium access control (MAC) control element (MAC-CE) including the information indicative of the partitioning.

Aspect 30 is the first network of any of aspects 24-29, where to transmit the information indicative of the partitioning, the at least one processor is configured to transmit downlink control information (DCI) or radio resource control (RRC) signaling including the information indicative of the partitioning.

Aspect 31 is a method of wireless communication for implementing any of aspects 1 to 9 and 19 to 23.

Aspect 32 is an apparatus for wireless communication including means for implementing any of aspects 1 to 9 and 19 to 23.

Aspect 33 is a computer-readable medium (e.g., a non-transitory computer-readable storage medium) storing computer executable code, where the code when executed by a processor causes the processor to implement any of aspects 1 to 9 and 19 to 23.

Aspect 34 is a method of wireless communication for implementing any of aspects 10 to 18 and 24 to 30.

Aspect 35 is an apparatus for wireless communication including means for implementing any of aspects 10 to 18 and 24 to 30.

Aspect 36 is a computer-readable medium (e.g., a non-transitory computer-readable storage medium) storing computer executable code, where the code when executed by a processor causes the processor to implement any of aspects 10 to 18 and 24 to 30.

1. A first network entity for wireless communication, comprising:
a memory; and
at least one processor coupled to the memory, wherein the at least one processor is configured to:
transmit, for a second network entity, information indicative of partitioning of one or more subsets of codebooks in a configured set of codebooks and information indicative of one recommended subset of codebooks in the one or more subsets of codebooks, wherein each respective codebook in the set of codebooks corresponds to a respective precoder;
receive, in an uplink grant from the second network entity, information indicative of a selected codebook in the recommended subset of codebooks; and
transmit a physical uplink shared channel (PUSCH) transmission based on the selected codebook and the uplink grant.

2. The first network entity of claim 1, wherein the at least one processor is configured to:
determine the partitioning of the one or more subsets of codebooks and the recommended subset of codebooks based on an antenna layout associated with the first network entity.

3. The first network entity of claim 2, wherein to determine the partitioning of the one or more subsets of codebooks and the recommended subset of codebooks, the at least one processor is configured to determine the partitioning of the one or more subsets of codebooks and the recommended subset of codebooks based on at least one of:
a local antenna blockage associated with the first network entity,
a power consumption associated with the first network entity, or
a channel measurement associated with the first network entity.

4. The first network entity of claim 2, wherein the at least one processor is configured to:
determine a second partitioning of the one or more subsets of codebooks based on at least one of:
a local antenna blockage associated with the first network entity,
a power consumption associated with the first network entity, or
a channel measurement associated with the first network entity; and
transmit, for the second network entity, information indicative of the second partitioning.

5. The first network entity of claim 2, wherein the at least one processor is configured to:
receive, from the second network entity, information indicative of a second partitioning of the one or more subsets of codebooks.

6. The first network entity of claim 5, wherein the at least one processor is configured to:
receive, from the second network entity, information indicative of a second selected codebook in the recommended subset of the one or more subsets of codebooks based on the second partitioning; and
transmit a second PUSCH transmission based on the second selected codebook.

7. The first network entity of claim 6, wherein the second partitioning is based on at least a decoding result associated with the first PUSCH transmission.

8. The first network entity of claim 1, wherein to transmit the information indicative of the partitioning, the at least one processor is configured to transmit an uplink medium access control (MAC) control element (MAC-CE) comprising the information indicative of the partitioning.

9. The first network entity of claim 1, wherein to transmit the information indicative of the partitioning, the at least one processor is configured to transmit uplink control information (UCI) or radio resource control (RRC) signaling comprising the information indicative of the partitioning, wherein the RRC signaling further comprises capability information associated with the first network entity.

10. A first network entity for wireless communication, comprising:
a memory; and
at least one processor coupled to the memory, wherein the at least one processor is configured to:
receive information indicative of partitioning of one or more subsets of codebooks in a configured set of codebooks for a second network entity and information indicative of one recommended subset of codebooks in the one or more subsets of codebooks, wherein each respective codebook in the set of codebooks corresponds to a respective precoder;
transmit, in an uplink grant for the second network entity, information indicative of a selected codebook in the recommended subset of codebooks; and
receive a physical uplink shared channel (PUSCH) transmission based on the selected codebook and the uplink grant.

11. The first network entity of claim 10, wherein the partitioning of the one or more subsets of codebooks and the recommended subset of codebooks are based on an antenna layout associated with the second network entity.

12. The first network entity of claim 11, wherein the partitioning of the one or more subsets of codebooks and the recommended subset of codebooks are based on at least one of:
a local antenna blockage associated with the second network entity,
a power consumption associated with the second network entity, or
a channel measurement associated with the second network entity.

13. The first network entity of claim 11, wherein the at least one processor is configured to:
receive information indicative of a second partitioning of the one or more subsets of codebooks, wherein the second partitioning is based on at least one of:
a local antenna blockage associated with the second network entity,
a power consumption associated with the second network entity, or
a channel measurement associated with the second network entity.

14. The first network entity of claim 11, wherein the at least one processor is configured to:
determine a second partitioning of the one or more subsets of codebooks; and
transmit information indicative of the second partitioning of the one or more subsets of codebooks.

15. The first network entity of claim 14, wherein the at least one processor is configured to:
transmit, for the second network entity, information indicative of a second selected codebook in the recommended subset of the one or more subsets of codebooks based on the second partitioning; and
receive a second PUSCH transmission based on the second selected codebook.

16. The first network entity of claim 15, wherein to determine the second partitioning, the at least one processor is configured to determine the second partitioning based on at least a decoding result associated with the first PUSCH transmission and a machine learning model.

17. The first network entity of claim 10, wherein to receive the information indicative of the partitioning, the at least one processor is configured to receive an uplink medium access control (MAC) control element (MAC-CE) comprising the information indicative of the partitioning.

18. The first network entity of claim 10, wherein to receive the information indicative of the partitioning, the at least one processor is configured to receive uplink control information (UCI) or radio resource control (RRC) signaling comprising the information indicative of the partitioning, wherein the RRC signaling further comprises capability information associated with the second network entity.

19. A first network entity for wireless communication, comprising:
a memory; and
at least one processor coupled to the memory, wherein the at least one processor is configured to:
receive, from a second network entity, information indicative of partitioning of one or more subsets of codebooks in a configured set of codebooks and one recommended subset of codebook in the one or more subsets of codebooks, wherein each respective codebook in the set of codebooks corresponds to a respective precoder;
receive, in an uplink grant from the second network entity, information indicative of a selected codebook in the recommended subset of codebooks; and
transmit a physical uplink shared channel (PUSCH) transmission based on the selected codebook and the uplink grant.

20. The first network entity of claim 19, wherein the at least one processor is configured to:
receive information indicative of a second partitioning of the one or more subsets of codebooks.

21-30. (canceled)
